(19) United States
(12) Patent Application Publication
(10) Pub. No.: US 2019/0152794 A1
(43) Pub. Date: May 23, 2019

(54) LAYERED DOUBLE HYDROXIDES

(71) Applicants: SCG Chemicals Co., Ltd., Bangkok (TH); SCG Packaging Public Company Limited, Bangkok (TH)

(72) Inventors: Dermot O'Hare, Oxford (GB); Jean-Charles Buffet, Oxford (GB); Kanittika Ruengkajorn, Nakhon Pathom (TH)

(73) Assignees: SCG Chemicals Co., Ltd., Bangkok (TH); SCG Packaging Public Company Limited, Bangkok (TH)

(21) Appl. No.: 16/308,592

(22) PCT Filed: May 25, 2017
(86) PCT No.: PCT/GB2017/051471

§ 371 Date: Dec. 10, 2018

(30) Foreign Application Priority Data
Jun. 17, 2016 (GB) 1610663.5

(51) Int. Cl. C01F 7/00

(52) U.S. Cl. CPC C01F 7/004; C01P 2002/22; C01P 2002/72; C01P 2002/77; C01P 2006/11; C01P 2006/10; C01P 2004/03; C01P 2006/12; C01P 2006/14; C01P 2002/88

(57) ABSTRACT

Layered double hydroxides (LDHs) are disclosed, as well as methods by which they may be manufactured. The LDHs are subjected to a solvent treatment step during manufacture, which confers high surface area and pore volume properties to the LDHs. The particular solvents used in the preparation of the LDHs renders allows for an overall more efficient and environmentally-friendly manufacturing process.

### INTRODUCTION

The present invention relates to layered double hydroxides and their methods of manufacture. More particularly, the present invention relates to layered double hydroxides having high surface area and their methods of manufacture.

### BACKGROUND OF THE INVENTION

Layered double hydroxides (LDHs) are a class of compounds which comprise two metal cations and have a layered structure. A review of LDHs is provided in Structure and Bonding; Vol 119, 2005 Layered Double Hydroxides ed. X Duan and D. G. Evans. The hydrotalcites, perhaps the most well-known examples of LDHs, have been studied for many years. LDHs can intercalate anions between the layers of the structure. WO 99/24139 discloses the use of LDHs to separate anions including aromatic and aliphatic anions.

Owing to the relatively high surface charge and hydrophilic properties of LDHs, the particles or crystallites of conventionally synthesised LDHs are generally highly aggregated. The result of this is that, when produced, LDHs aggregate to form “stone-like”, non-porous bodies with large particle sizes of up to several hundred microns and low specific surface area of generally 5 to 15 m²/g (as disclosed for example in Wang et al Catal. Today 2011, 164, 198). Reports by e.g. Adachi-Pagano et al (Chem. Commun. 2000, 91) of relatively high surface area LDHs have specific surface areas no higher than 5 to 120 m²/g.

In certain applications (for example adsorbents or catalyst supports), it would be advantageous to provide LDHs with higher surface areas than those discussed above. Relatively high surface areas would lead to a greater number of active sites and facilitate mass transport from the surface to bulk.

WO2014/051530 and WO2015/144778 disclose processes of preparing higher surface area LDHs involving a post-production step of treating the LDH with a solvent that is miscible with water.

In spite of recent advances, there remains a need for optimized methods of manufacturing high surface area LDHs, as well as high surface area LDHs resulting from such methods.

The present invention was devised with the foregoing in mind.

### SUMMARY OF THE INVENTION

According to a first aspect of the present invention there is provided a process for preparing a layered-double hydroxide of formula (I) shown below:

[M^{z+}₁₋ₓM′^{y+}ₓ(OH)₂]^{a}^{₊}(Xⁿ⁻)_{a/n}·bH₂O·c(AIM-solvent) (I)

wherein
M is a charged metal cation;
M′ is a charged metal cation different from M;
z is 1 or 2;
y is 3 or 4;
0<x<0.9;
0<b≤10;
0<c≤10;
X is an anion;
n is the charge on anion X;
a is equal to z(1−x)+xy−2; and
“AIM-solvent” denotes a solvent selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, 2-pentanone, 3-methyl-2-butanone, 3-pentanone, 2,4-dimethyl-3-pentanone, 4-heptanone, 5-nonanone, and a mixture of two or more thereof;
   said process comprising the steps of;
a) providing a water-washed, wet precipitate of formula (II) shown below, said precipitate having been formed by contacting aqueous solutions containing cations of the metals M and M′, and the anion Xⁿ⁻, and then ageing the reaction mixture:

[M^{z+}₁₋ₓM′^{y+}ₓ(OH)₂]^{a}^{₊}(Xⁿ⁻)_{a/n}·bH₂O (II)
wherein M, M′, z, y, x, a, b and X are as defined for formula (I);
b) dispersing the water-washed, wet precipitate of step a) in an AIM-solvent as defined for formula (I) to produce a slurry; and
c) maintaining the slurry resulting from step b).

According to a further aspect of the present invention, there is provided a layered double hydroxide of formula (I) obtainable, obtained or directly obtained by a process defined herein.

According to a further aspects of the present invention, there is provided a layered double hydroxide of formula (I) shown below:

[M^{z+}₁₋ₓM′^{y+}ₓ(OH)₂]^{a}^{₊}(Xⁿ⁻)_{a/n}·bH₂O·c(AIM-solvent) (I)

wherein
M is a charged metal cation
M′ is a charged metal cation different from M
z is 1 or 2
y is 3 or 4
0<x<0.9
0<b≤10
0<c≤10
X is an anion
n is the charge on anion X
a is equal to z(1−x)+xy−2; and
“AIM-solvent” denotes solvent selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, 2-pentanone, 3-methyl-2-butanone, 3-pentanone, 2,4-dimethyl-3-pentanone, 4-heptanone, 5-nonanone, and a mixture of two or more thereof.

### DETAILED DESCRIPTION OF THE INVENTION

### Processes of the Invention

As described hereinbefore, the present invention provides a process for preparing a layered-double hydroxide of formula (I) shown below:

[M^{z+}₁₋ₓM′^{y+}ₓ(OH)₂]^{a}^{₊}(Xⁿ⁻)_{a/n}·bH₂O·c(AIM-solvent) (I)

wherein
M is a charged metal cation;
M′ is a charged metal cation different from M;
z is 1 or 2;
y is 3 or 4;
0<x<0.9;
0<b≤10;
0<c≤10;
X is an anion;
n is the charge on anion X;
a is equal to z(1−x)+xy−2; and
“AIM-solvent” denotes a solvent selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, 2-pentanone, 3-methyl-2-butanone, 3-pentanone, 2,4-dimethyl-3-pentanone, 4-heptanone, 5-nonanone, and a mixture of two or more thereof;
   said process comprising the steps of;
a) providing a water-washed, wet precipitate of formula (II) shown below, said precipitate having been formed by contacting aqueous solutions containing cations of the metals M and M′, and the anion Xⁿ⁻, and then ageing the reaction mixture:

[M^{z+}₁₋ₓM′^{y+}ₓ(OH)₂]^{a}^{₊}(Xⁿ⁻)_{a/n}·bH₂O (II)
wherein M, M′, z, y, x, a, b and X are as defined for formula (I);
b) dispersing the water-washed, wet precipitate of step a) in an AIM-solvent as defined for formula (I) to produce a slurry; and
c) maintaining the slurry resulting from step b).

Through extensive studies, the inventors have now found that prior art techniques previously used to prepare high surface area LDHs can be markedly improved upon. In particular, the inventors have discovered that a novel post-preparation step of treating a pre-prepared LDH with a solvent having particular properties not only results in the formation of a high surface area LDH, but also considerably optimises the manufacturing process as a whole.

Compared to those prior art techniques that call for the use of an aqueous miscible solvent in a post-preparation treatment step, the inventors have now discovered have now identified numerous advantages associated with using solvents having radically different properties. In particular, the inventors have identified that both the hydrogen-bonding characteristics of a given solvent and its immiscibility with water collectively contribute to the formation of high surface area LDHs in the processes in the invention. Without wishing to be bound by theory, the inventors have hypothesised that by treating pre-prepared LDH with an organic solvent having hydrogen bonding characteristics (e.g. as donor or acceptor), residual water present between the layers of the LDH or on its surface can be efficiently removed. The removal of this residual water greatly reduces the extent to which individual LDH particulates or crystallites aggregate through hydrogen-bonding of residual water present on their surfaces, thereby resulting in a finer, free-flowing LDH powder having high surface area. In addition, the use of an aqueous immiscible solvent in the post-production treatment step greatly enhances the efficiency of the manufacturing process as a whole. In particular, when compared with aqueous miscible solvents whose separation from water requires energy-intensive distillation techniques, using an aqueous immiscible solvent in the post-production treatment step allows the solvent to be easily separated from the displaced residual water at the end of the treatment step (e.g. by simple partitioning), meaning that the solvent can be readily recycled for use in further sequential post-treatment steps of the same LDH, or in the post-treatment of a new batch of precipitated LDH. Hence, the use of an aqueous immiscible solvent allows for an overall more efficient and environmentally-friendly method of manufacturing high surface area LDHs.

In an embodiment, the AIM-solvent is selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, and a mixture of two or more thereof.

In an embodiment, the AIM-solvent is selected from the group consisting of n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, cyclohexanone, methyl ethyl ketone (MEK), methyl isobutyl ketone (MIBK), methyl isoamyl ketone, methyl n-amyl ketone, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 1-hexanol, triethylamine, nitromethane, and a mixture of two or more thereof.

In an embodiment, the AIM-solvent is selected from the group consisting of n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, cyclohexanone, methyl ethyl ketone (MEK), methyl isobutyl ketone (MIBK), methyl isoamyl ketone, methyl n-amyl ketone, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, nitromethane, and a mixture of two or more thereof.

In an embodiment, the AIM-solvent is selected from the group consisting of diethyl ether, diisopropyl ether, di-n-butyl ether, cyclohexanone, methyl ethyl ketone (MEK), methyl isobutyl ketone (MIBK), methyl acetate, isopropyl acetate, n-propyl acetate, isobutyl acetate, 1-hexanol, triethylamine, nitromethane, and a mixture of two or more thereof.

In an embodiment, the AIM-solvent is selected from the group consisting of diethyl ether, diisopropyl ether, di-n-butyl ether, cyclohexanone, methyl ethyl ketone (MEK), methyl isobutyl ketone (MIBK), methyl acetate, isopropyl acetate, n-propyl acetate, isobutyl acetate, and a mixture of two or more thereof.

In an embodiment, the AIM-solvent is selected from the group consisting of m-cresol, o-cresol, p-cresol, n-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl isobutyl ketone (MIBK), methyl isoamyl ketone, methyl n-amyl ketone, isophorone, furfural, isopropyl acetate, n-propyl acetate, isobutyl acetate, n-butyl acetate, n-amyl acetate, n-hexyl acetate, methyl amyl acetate, 2-butoxyethyl acetate, n-butyl propionate, n-pentyl propionate, 2-nitropropane, aniline, N,N-dimethylaniline, and a mixture of two or more thereof.

In an embodiment, the AIM-solvent is selected from the group consisting of diethyl ether, diisopropyl ether, di-n-butyl ether, cyclohexanone, methyl isobutyl ketone (MIBK), isopropyl acetate, n-propyl acetate, isobutyl acetate, and a mixture of two or more thereof.

In an embodiment, the AIM-solvent is selected from the group consisting of diethyl ether, diisopropyl ether, di-n-butyl ether, 1-butanol, 1-hexanol, methyl ethyl ketone, methyl tert-butyl ether, tert-amyl methyl ether, cyclopentyl methyl ether, anisole, 2-petanone, 3-methyl-2-butanone, 4-methyl-2-pentanone, 3-pentanone, 2,4-dimethyl-3-pentanone, 4-heptanone, 5-nonanone, and a mixture of two or more thereof.

In an embodiment, the AIM-solvent is selected from the group consisting of diethyl ether, diisopropyl ether, di-n-butyl ether, 1-hexanol, methyl ethyl ketone, methyl tert-butyl ether, tert-amyl methyl ether, cyclopentyl methyl ether, anisole, 4-methyl-2-pentanone, and a mixture of two or more thereof.

Organic solvents that are highly miscible with water (e.g. acetone and ethanol) are not used in the process of the invention.

The high surface area LDHs of the invention may be prepared, supplied and used as dispersions in the slurry formed in step b) and maintained in step c). Alternatively, in another embodiment, the process further comprises a step d) of isolating the layered double hydroxide resulting from step c).

When the process includes a step d) of isolating the layered double hydroxide resulting from step c), the layered double hydroxide may be isolated by a variety of means, including filtering, filter pressing, spray drying, cycloning and centrifuging. The isolated layered double hydroxide may then be dried to give a free-flowing powder. The drying may be performed under ambient conditions, in a vacuum, or by heating to a temperature below 60° C. (e.g. 20 to 60° C.). Suitably, in step d), the layered double hydroxide resulting from step c) is isolated and then heated to a temperature of 10-40° C. in a vacuum until a constant mass is reached.

In an embodiment, when z is 2, M is Mg, Zn, Fe, Ca, Sn, Ni, Cu, Co, Mn or Cd or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Ga, Y, In, Fe, Co, Ni, Mn, Cr, Ti, V, La or a mixture thereof, or when y is 4, M′ is Sn, Ti or Zr or a mixture thereof. Suitably, y is 3. More suitably, y is 3 and M′ is Al.

In an embodiment, x has a value according to the expression 0.18<x<0.9. Suitably, x has a value according to the expression 0.18<x<0.5. More suitably, x has a value according to the expression 0.18<x<0.4.

In an embodiment, b has a value according to the expression 0<b≤7.5. Suitably, b has a value according to the expression 0<b≤5. More suitably, b has a value according to the expression 0<b≤3. Most suitably, b has a value according to the expression 0<b≤1.5.

In an embodiment, c has a value according to the expression 0<c≤7.5. Suitably, c has a value according to the expression 0<c≤5. More suitably, c has a value according to the expression 0<c≤1. More suitably, c has a value according to the expression 0<c≤0.5. Most suitably, c has a value according to the expression 0<c≤0.35. The lower limit for c may be, for example, 0.001.

In an embodiment, the layered double hydroxide of formula (I) is a Zn/Al, Mg/Al, Ca/Al, Ni/Al or Cu/Al layered double hydroxide.

The anion X in the LDH may be any appropriate organic or inorganic anion, for example halide (e.g., chloride), inorganic oxyanions (e.g. X′ₘOₙ(OH)ₚ^{-q}; m=1-5; n=2-10; p=0-4, q=1-5; X′=B, C, N, S, P: e.g. carbonate, bicarbonate, hydrogenphosphate, dihydrogenphosphate, nitrite, borate, nitrate, phosphate, sulphate), anionic surfactants (such as sodium dodecyl sulfate, fatty acid salts or sodium stearate), anionic chromophores, and/or anionic UV absorbers, for example 4-hydroxy-3-10 methoxybenzoic acid, 2-hydroxy-4 methoxybenzophenone-5-sulfonic acid (HMBA), 4-hydroxy-3-methoxy-cinnamic acid, p-aminobenzoic acid and/or urocanic acid. In an embodiment, the anion X is an inorganic oxyanion selected from carbonate, bicarbonate, hydrogenphosphate, dihydrogenphosphate, nitrite, borate, nitrate, sulphate or phosphate or a mixture of two or more thereof. More suitably, the anion X is an inorganic oxyanion selected from carbonate, bicarbonate, nitrate or nitrite. Most suitably, the anion X is carbonate.

In a particularly suitable embodiment, M is Ca, Mg, Zn or Fe, M′ is Al, and X is carbonate, bicarbonate, nitrate or nitrite. Suitably, M is Ca, Mg or Zn, M′ is Al, and X is carbonate, bicarbonate, nitrate or nitrite. More suitably, M is Ca, Mg or Zn, M′ is Al, and X is carbonate.

The term “water-washed wet precipitate of formula (II)” used in step a) will be understood to define a material having a composition defined by formula (II) which has been precipitated out of a solution of reactants and has subsequently been washed with water and then dried and/or filtered to the point that it is still damp. The wet precipitate may have a moisture content of 30 to 50% relative to the total weight of the wet precipitate.

In an embodiment, the water-washed wet precipitate of formula (II) is a wet cake. The term wet cake will be familiar to one of ordinary skill in the art. For example, the wet cake may be the product obtained by washing the precipitate of formula (II) with water, and then filtering off a portion of the residual water (e.g. under reduced pressure) to leave a damp solid (e.g. of moisture content 30 to 50% relative to the total weight of the solid).

It will be understood that the water-washed wet precipitate of step a) may be pre-formed. Alternatively, the water-washed wet precipitate of step a) may be prepared as part of step a), in which case step a) comprises the following steps:
(i) precipitating a layered double hydroxide having the formula (II) from an aqueous solution containing cations of the metals M and M′, and the anion Xⁿ⁻;
(ii) ageing the layered double hydroxide precipitate obtained in step (i) in the reaction mixture of step (i);
(iii) collecting the aged precipitate resulting from step (ii), then washing it with water; and
(iv) drying and/or filtering the washed precipitate to the point that it is still damp.

In an embodiment, in step a)(i), the precipitate is formed by contacting aqueous solutions containing cations of the metals M and M′, and the anion Xⁿ⁻, in the presence of a base being a source of OH⁻ (e.g. NaOH, NH₄OH, or a precursor for OH⁻formation). Suitably the base is NaOH. In an embodiment, the quantity of base used is sufficient to control the pH of the solution at 6.5-13. Suitably, the quantity of base used is sufficient to control the pH of the solution at 7.5-13. More suitably, the quantity of base used is sufficient to control the pH of the solution at 9-11.

In an embodiment, in step a)(ii), the layered double hydroxide precipitate obtained in step (i) is aged in the reaction mixture of step (i) for a period of 5 minutes to 72 hours at a temperature of 1-100° C.

Suitably, in step a)(ii), the layered double hydroxide precipitate obtained in step (i) is aged in the reaction mixture of step (i) for a period of 1 to 72 hours. More suitably, in step a)(ii), the layered double hydroxide precipitate obtained in step (i) is aged in the reaction mixture of step (i) for a period of 5 to 48 hours. Most suitably, in step a)(ii), the layered double hydroxide precipitate obtained in step (i) is aged in the reaction mixture of step (i) for a period of 12 to 36 hours.

Suitably, in step a)(ii), the layered double hydroxide precipitate obtained in step (i) is aged in the reaction mixture of step (i) at a temperature of 10-60° C. More suitably, in step a)(ii), the layered double hydroxide precipitate obtained in step (i) is aged in the reaction mixture of step (i) at a temperature of 10-40° C.

In an embodiment, in step a)(iii), the aged precipitate resulting from step (ii) is collected, then washed with water (e.g. using a Buchner apparatus under ambient conditions) until the filtrate has a pH in the range of 6.5-7.5.

In an embodiment, in step a)(iv), the washed precipitate is subjected to drying and/or filtration under reduced pressure at a temperature of 10-35° C. (e.g. using a Buchner apparatus under ambient conditions) to yield a wet cake of precipitate. Optionally, after step a)iv), the wet cake is taken up in an excess of water and step a)iv) is then repeated.

In an embodiment, the water-washed wet precipitate of step a) may be the product of a urea hydrothermal LDH preparation process. Urea hydrothermal processes are well-documented in the art, and give rise to well-crystallised, large platelet-like (as opposed to rosette/flower-type) LDHs.

In step b), the water-washed wet precipitate of formula (II) resulting from step a) is dispersed in an AIM-solvent as defined herein to produce a slurry. Optionally, prior to step b), the water-washed wet precipitate of formula (II) resulting from step a) is first washed (e.g. using Buchner apparatus under ambient conditions) with at least one AIM-solvent as defined herein.

In an embodiment, the slurry produced in step b) and then maintained in step c) contains 1-100 g of water-washed wet precipitate per 1 L of AIM-solvent. Suitably, the slurry produced in step b) and maintained in step c) contains 1-75 g of water-washed wet precipitate per 1 L of AIM-solvent. More suitably, the slurry produced in step b) and maintained in step c) contains 1-50 g of water-washed wet precipitate per 1 L of AIM-solvent. Most suitably, the slurry produced in step b) and maintained in step c) contains 1-30 g of water-washed wet precipitate per 1 L of AIM-solvent.

In step c), the slurry produced in step b) is maintained for a period of time. Suitably, the slurry is stirred during step c).

In an embodiment, in step c), the slurry is maintained for a period of 0.5 to 96 hours. Suitably, in step c), the slurry is maintained for a period of 0.5 to 72 hours. More suitably, in step c), the slurry is maintained for a period of 0.5 to 48 hours. Even more suitably, in step c), the slurry is maintained for a period of 0.5 to 24 hours. Yet more suitably, in step c), the slurry is maintained for a period of 0.5 to 10 hours. Most suitably, in step c), the slurry is maintained for a period of 1 to 8 hours.

In an embodiment, the process further comprises a step e) of contacting the layered double hydroxide isolated in step d) with at least one AIM-solvent as defined herein. In certain embodiments, it may be advantageous to perform one or more additional AIM-solvent treatment steps on the precipitate isolated in step d). In an embodiment, in step e), the isolated layered double hydroxide is washed with at least one AIM solvent (e.g. using Buchner apparatus). Alternatively, step e) comprises the steps of:

i. dispersing the isolated layered double hydroxide in an AIM-solvent to form a slurry;

ii. maintaining the slurry for a period of 0.5 to 72 hours;

iii. isolating the layered double hydroxide resulting from step ii; and

iv. optionally repeating steps i. to iii. a further 1-10 times (e.g. once or twice).

Hence, step e) may comprise performing additional dispersion-maintaining-isolation cycles in order to remove residual water from the layered double hydroxide.

According to a further aspect of the invention, there is provided a process for preparing a layered-double hydroxide of formula (I) shown below:

[M^{z+}₁₋ₓM′^{y+}ₓ(OH)₂]^{a}^{₊}(Xⁿ⁻)_{a/n}·bH₂O·c(AIM-solvent) (I)

wherein
M is a charged metal cation;
M′ is a charged metal cation different from M;
z is 1 or 2;
y is 3 or 4;
0<x<0.9;
0<b≤10;
0<c≤10;
X is an anion;
n is the charge on anion X;
a is equal to z(1−x)+xy−2; and
“AIM-solvent” denotes a solvent having a water solubility of ≤80 g/L under ambient conditions and having one or more hydrogen bond donor and/or acceptor groups;
   said process comprising the steps of;
a) providing a water-washed, wet precipitate of formula (II) shown below, said precipitate having been formed by contacting aqueous solutions containing cations of the metals M and M′, and the anion Xⁿ⁻, and then ageing the reaction mixture:

[M^{z+}₁₋ₓM′^{y+}ₓ(OH)₂]^{a}^{₊}(Xⁿ⁻)_{a/n}·bH₂O (II)
wherein M, M′, z, y, x, a, b and X are as defined for formula (I);
b) dispersing the water-washed, wet precipitate of step a) in an AIM-solvent as defined for formula (I) to produce a slurry; and
c) maintaining the slurry resulting from step b).

It will be appreciated that M, M′, z, y, x, a, b, c and X can have any of those definitions appearing hereinbefore.

The AIM solvent may have any suitable hydrogen bond donor and/or acceptor groups. Hydrogen bond donor groups include R—OH, R—NH₂, R₂NH, whereas hydrogen bond acceptor groups include ROR, R₂C═O RNO₂, R₂NO, R₃N, ROH, RCF₃, where R represents a hydrocarbyl group of the AIM solvent. It will be understood that ambient conditions refers to a temperature of 10-40° C. and atmospheric pressure.

### LDHs of the Invention

As described hereinbefore, the present invention also provides a layered double hydroxide of formula (I) shown below:

[M^{z+}₁₋ₓM′^{y+}ₓ(OH)₂]^{a}^{₊}(Xⁿ⁻)_{a/n}·bH₂O·c(AIM-solvent) (I)

wherein
M is a charged metal cation
M′ is a charged metal cation different from M
z is 1 or 2
y is 3 or 4
0<x<0.9
0<b≤10
0<c≤10
X is an anion
n is the charge on anion X
a is equal to z(1−x)+xy−2; and
“AIM-solvent” denotes solvent selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, 2-pentanone, 3-methyl-2-butanone, 3-pentanone, 2,4-dimethyl-3-pentanone, 4-heptanone, 5-nonanone, and a mixture of two or more thereof.

The present invention also provides a layered double hydroxide of formula (I) obtainable, obtained or directly obtained by a process defined herein.

The LDHs of the invention present numerous advantages over those currently available. Perhaps most notably, the LDHs of the invention have particularly high surface areas and pore volumes, making them attractive candidates for use in a variety of catalytic applications and sorption processes. By virtue of the AIM-solvent treatment to which they are subjected, the LDHs of the invention may be referred to here as AIM-LDHs.

For the LDHs of the invention, M, M′, z, y, a, b, c, X, n and the AIM solvent may have any of those definitions appearing hereinbefore.

For the avoidance of doubt, the LDHs of the invention contain only those components (ions, anions, solvents, etc) recited in formula (I).

In an embodiment, b has a value according to the expression 0<b≤7.5. Suitably, b has a value according to the expression 0<b≤5. More suitably, b has a value according to the expression 0<b3. Most suitably, b has a value according to the expression 0<b≤1.5.

In an embodiment, c has a value according to the expression 0<c≤7.5. Suitably, c has a value according to the expression 0<c≤5. More suitably, c has a value according to the expression 0<c≤1. More suitably, c has a value according to the expression 0<c≤0.5. Most suitably, c has a value according to the expression 0<c≤0.35. The lower limit for c may be, for example, 0.001.

In an embodiment, the LDH has a BET surface area of at least 70 m²/g. Suitably, the LDH has a BET surface area of at least 180 m²/g. More suitably, the LDH has a BET surface area of at least 240 m²/g. Even more suitably, the LDH has a BET surface area of at least 275 m²/g. Most suitably, the LDH has a BET surface area of at least 300 m²/g. The high surface area of the LDHs makes them particularly attractive candidates for use as sorbents or support materials in catalytic applications.

In an embodiment, the layered double hydroxide has a BET pore volume of at least 0.5 cm³/g. Suitably, the layered double hydroxide has a BET pore volume of at least 0.75 cm³/g. More suitably, the layered double hydroxide has a BET pore volume of at least 0.9 cm³/g. The pore volume properties of the LDHs make them particularly attractive candidates for use in sorption technologies.

In an embodiment, the layered double hydroxide has a loose bulk density of less than 0.5 g/mL. Suitably, the layered double hydroxide has a loose bulk density of less than 0.35 g/mL. More suitably, the layered double hydroxide has a loose bulk density of less than 0.25 g/mL. In another embodiment, the layered double hydroxide has a tap density of less than 0.5 g/mL. Tap densities are calculated by standard testing method (ASTM D7481-09) using a graduated cylinder. The powder was filled into a cylinder and a precise weight of sample (m) was measured. The volume was measured before (V₀) and after 1000 taps (Vₜ). The loose bulk and tap densities were calculated by: Loose bulk density=m/V0; Tap density=m/Vₜ. Suitably, the layered double hydroxide has a tap density of less than 0.4 g/mL. More suitably, the layered double hydroxide has a tap density of less than 0.35 g/mL. The density properties of the LDHs make them particularly attractive candidates for use in sorption technologies.

The LDHs of the invention are suitably provided in a dry, particulate form. Alternatively, the LDHs of the invention may be provided as a dispersion or slurry in an AIM-solvent.

According to a further aspect of the invention, there is provided a layered double hydroxide of formula (I) shown below:

[M^{z+}₁₋ₓM′^{y+}ₓ(OH)₂]^{a}^{₊}(Xⁿ⁻)_{a/n}·bH₂O·c(AIM-solvent) (I)

wherein
M is a charged metal cation
M′ is a charged metal cation different from M
z is 1 or 2
y is 3 or 4
0<x<0.9
0<b≤10
0<c≤10
X is an anion
n is the charge on anion X
a is equal to z(1−x)+xy−2; and
“AIM-solvent” denotes a solvent having a water solubility of ≤80 g/L under ambient conditions and having one or more hydrogen bond donor and/or acceptor groups.

It will be appreciated that M, M′, z, y, x, a, b, c and X can have any of those definitions appearing hereinbefore.

The AIM-solvent may have any suitable hydrogen bond donor and/or acceptor groups. Hydrogen bond donor groups include R—OH, R—NH₂, R₂NH whereas hydrogen bond acceptor groups include ROR, R₂C═O RNO₂, R₂NO, R₃N, ROH, RCF₃, where R represents a hydrocarbyl group of the AIM solvent.

### EXAMPLES

Examples of the invention will now be described, for the purpose of illustration only, with reference to the accompanying figures, in which:

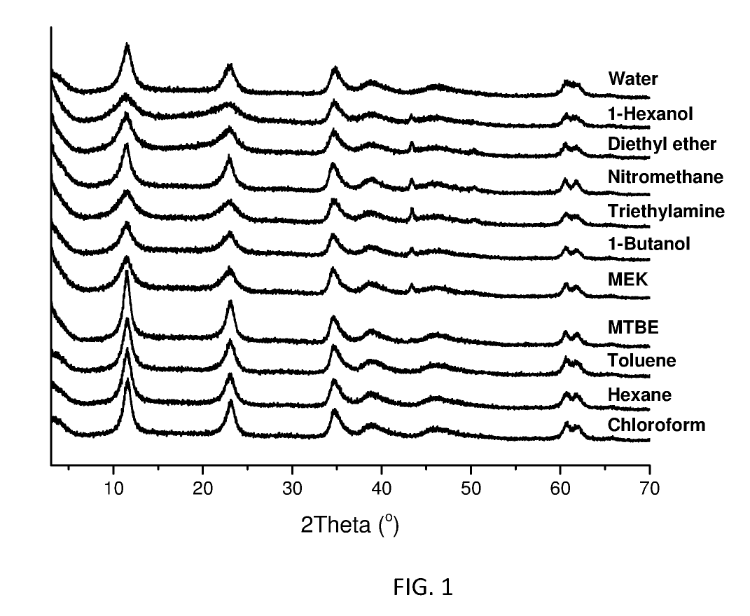

FIG. 1 shows X-ray powder crystallography for the LDHs of the invention, conventional LDH and other comparator LDHs.

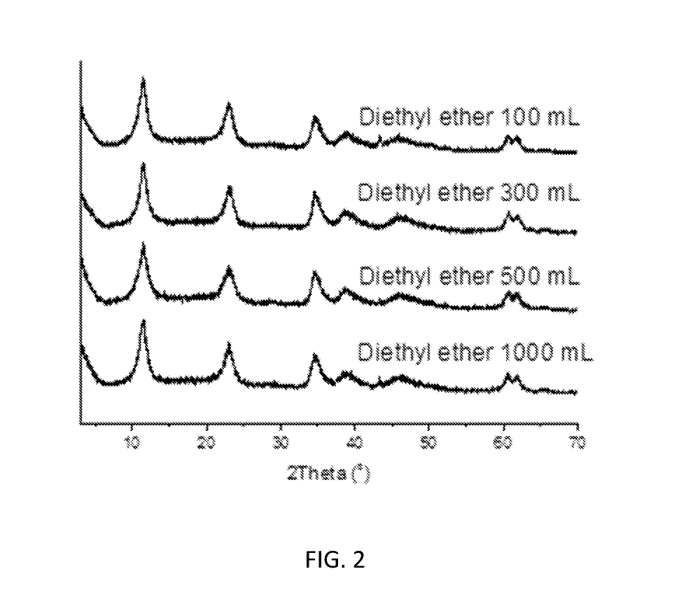

FIG. 2 shows X-ray powder crystallography for two LDHs of the invention subjected to different quantities of diethyl ether during the AIM-solvent treatment step.

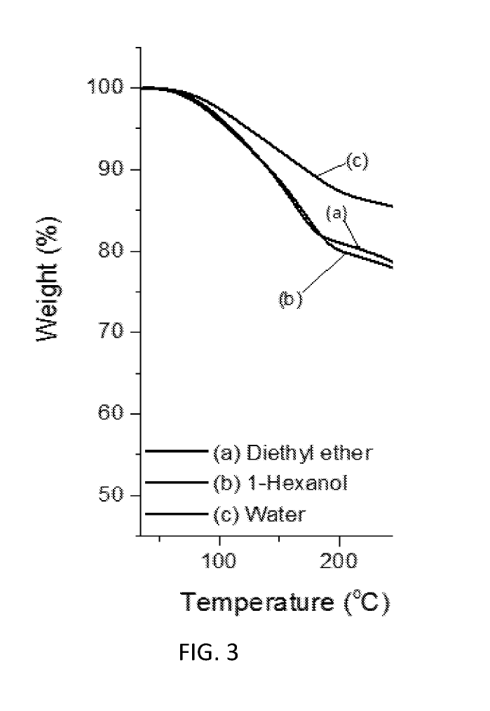

FIG. 3 shows TGA data for the LDHs of the invention and conventional LDH.

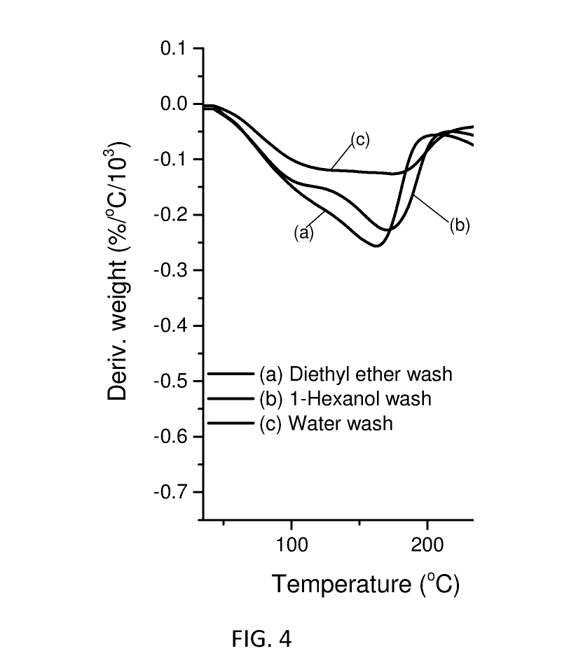

FIG. 4 shows dTGA data for the LDHs of the invention and conventional LDH.

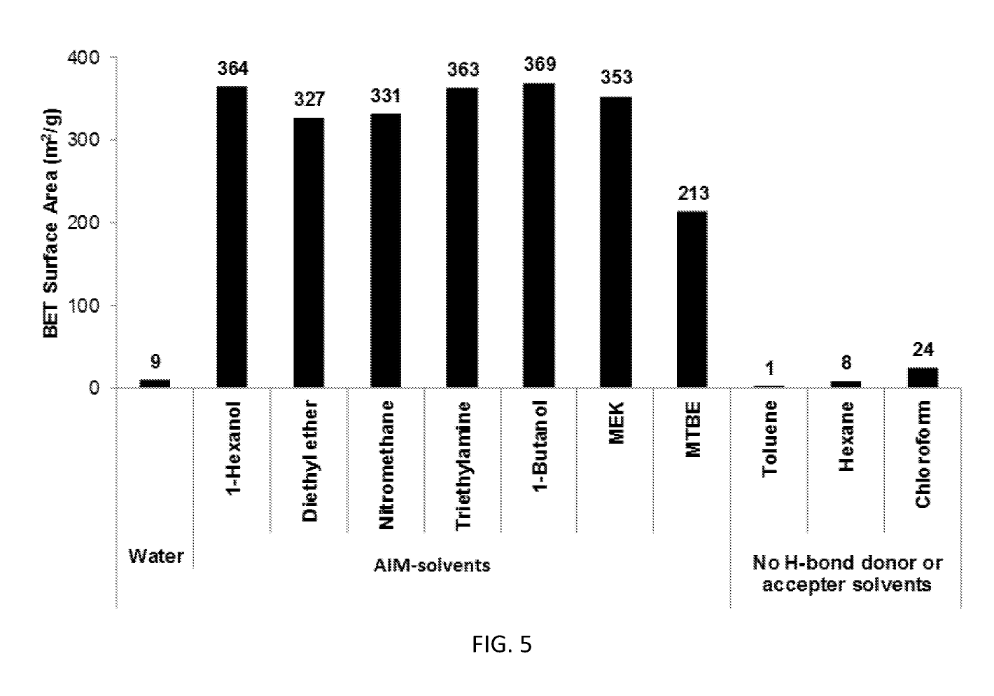

FIG. 5 shows BET surface area data for the LDHs of the invention, conventional LDH and other comparator LDHs.

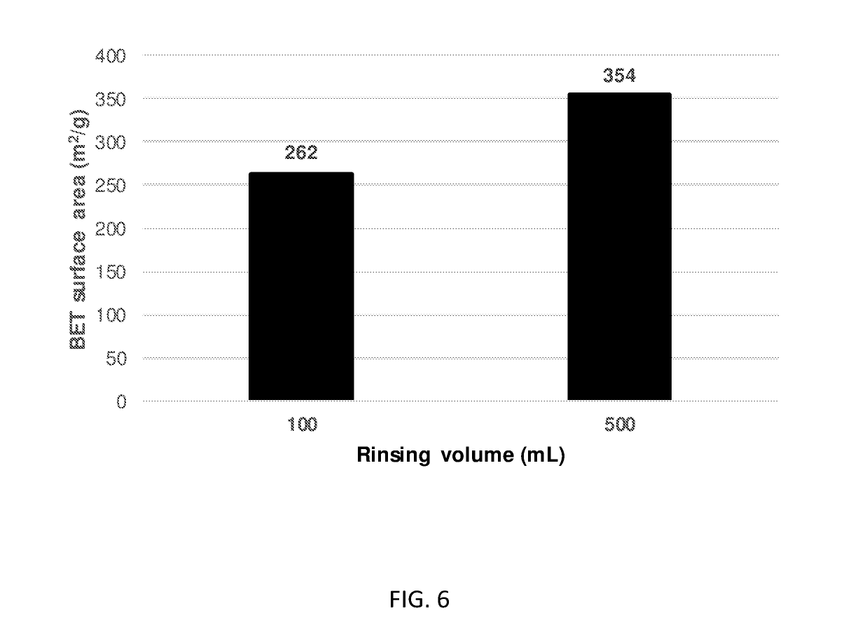

FIG. 6 shows BET surface area data for two LDHs of the invention subjected to different quantities of diethyl ether during the AIM-solvent treatment step.

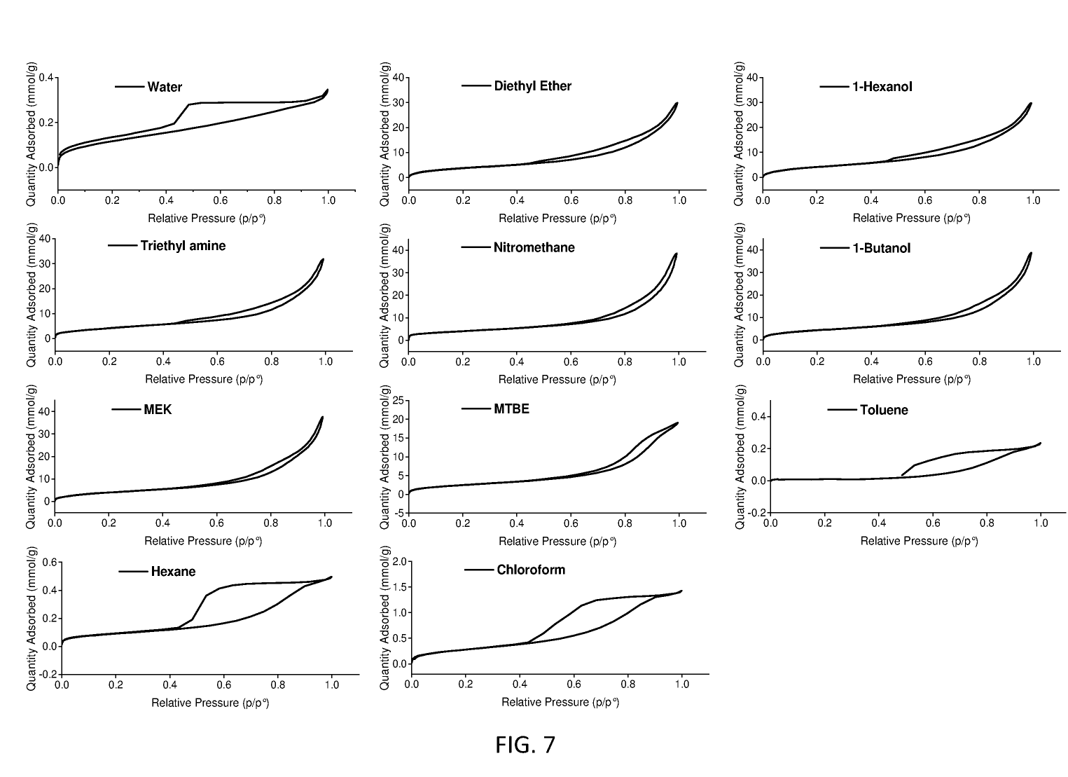

FIG. 7 shows BET data curves for the LDHs of the invention, conventional LDH and other comparator LDHs.

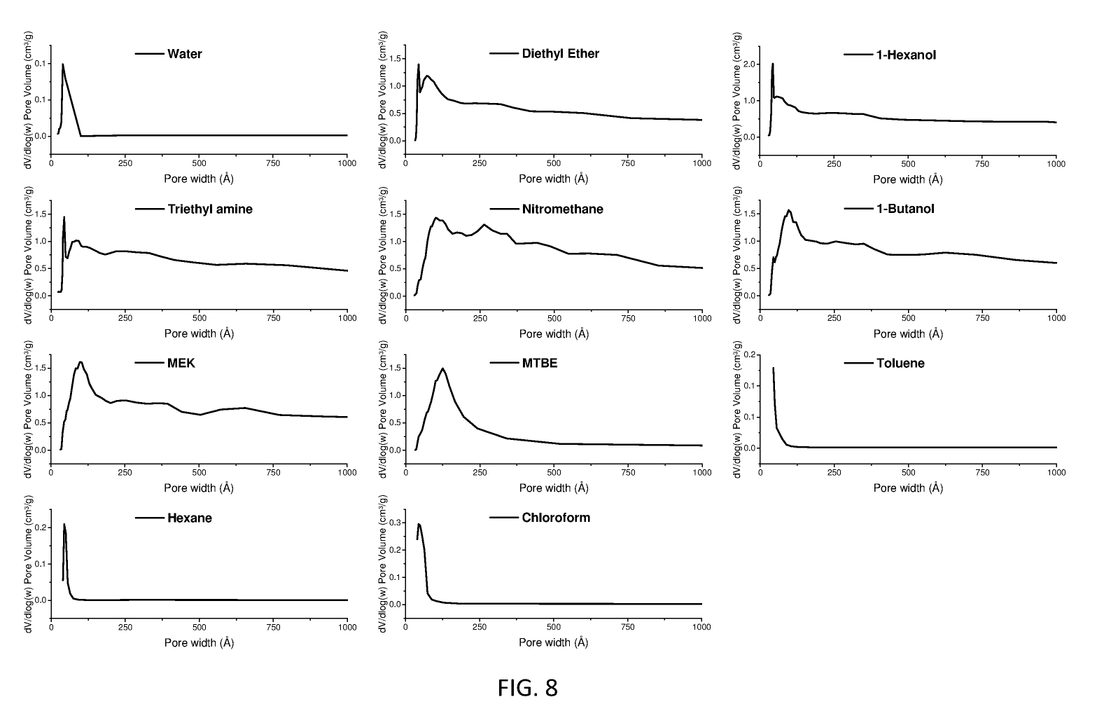

FIG. 8 shows pore volume data for the LDHs of the invention, conventional LDH and other comparator LDHs.

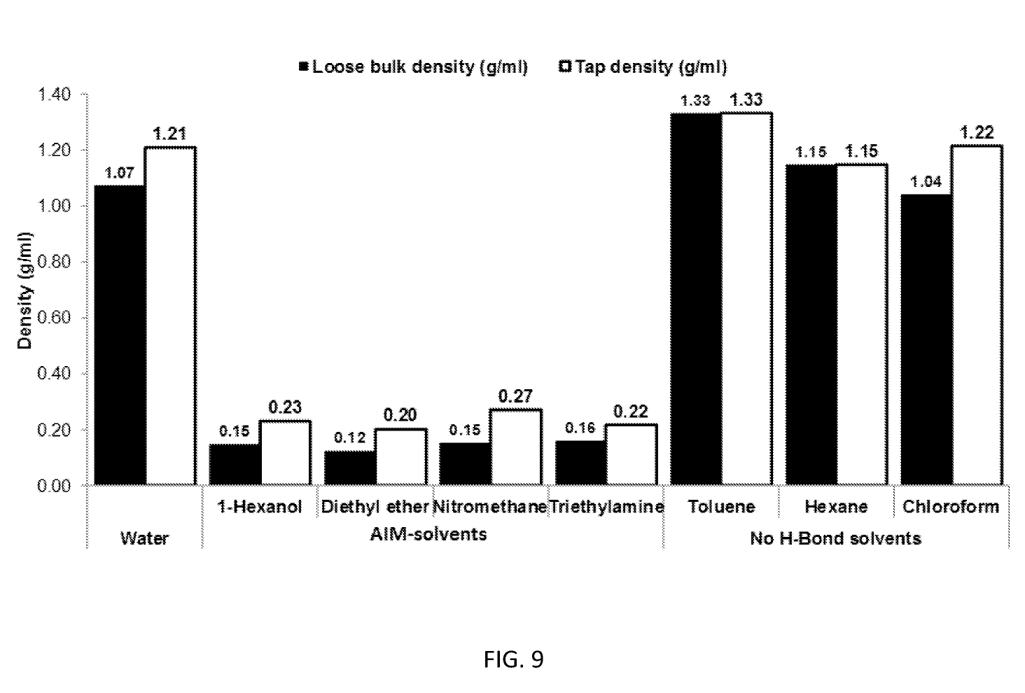

FIG. 9 shows density data for the LDHs of the invention, conventional LDH and other comparator LDHs.

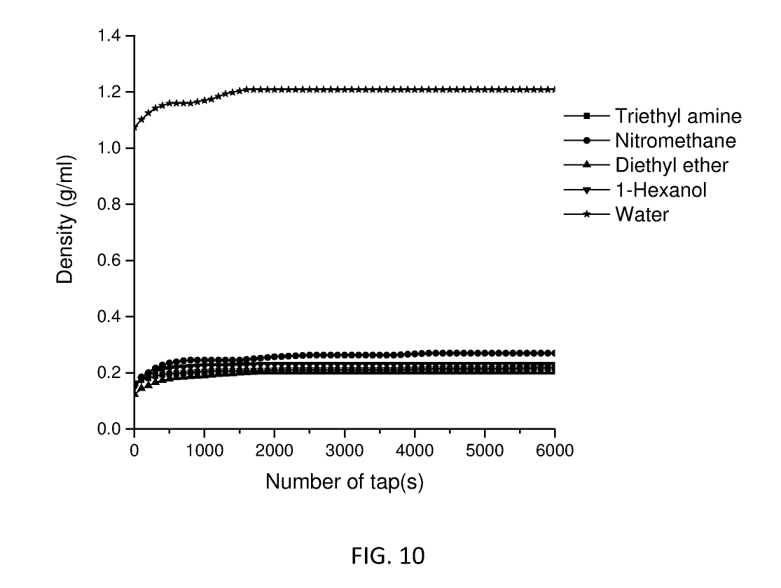

FIG. 10 shows tap density data for the LDHs of the invention and conventional LDH as a function of tap number.

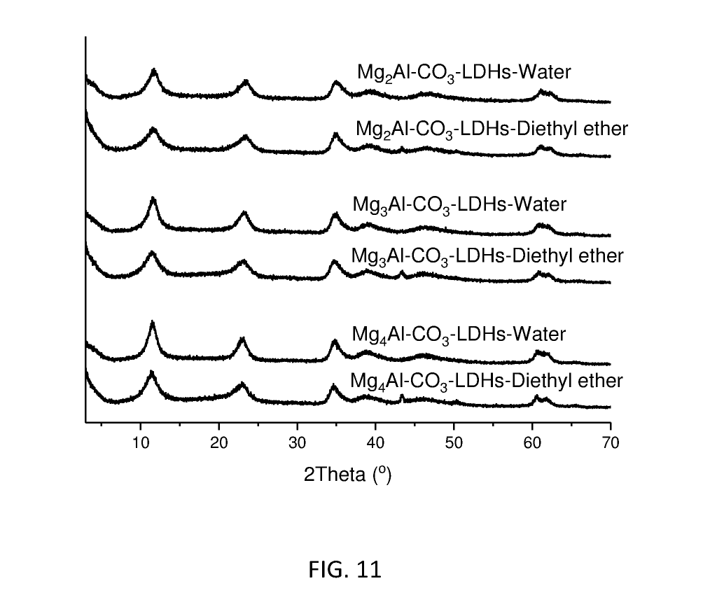

FIG. 11 shows XRD patterns of conventional LDHs and AIM-LDHs of the invention with different Mg/Al ratios.

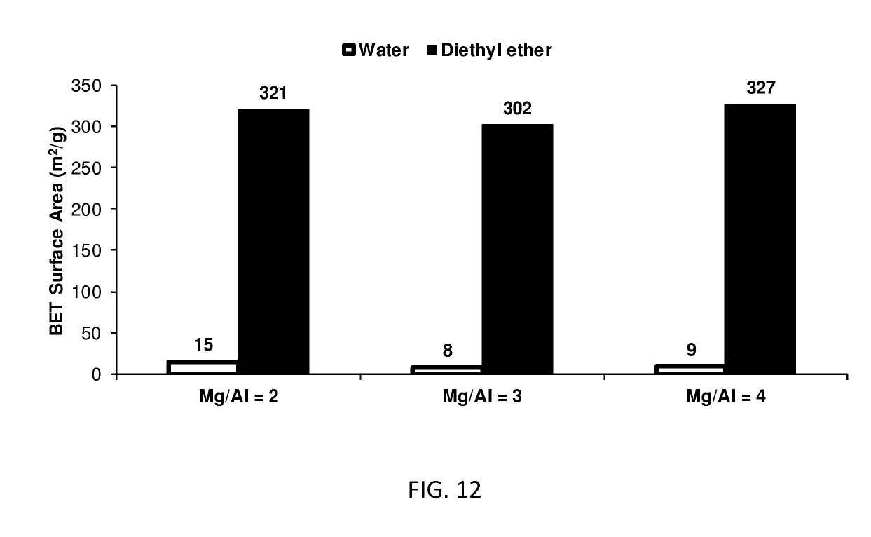

FIG. 12 shows BET surface area of AIM-LDHs of the invention with different ratios of Mg/Al.

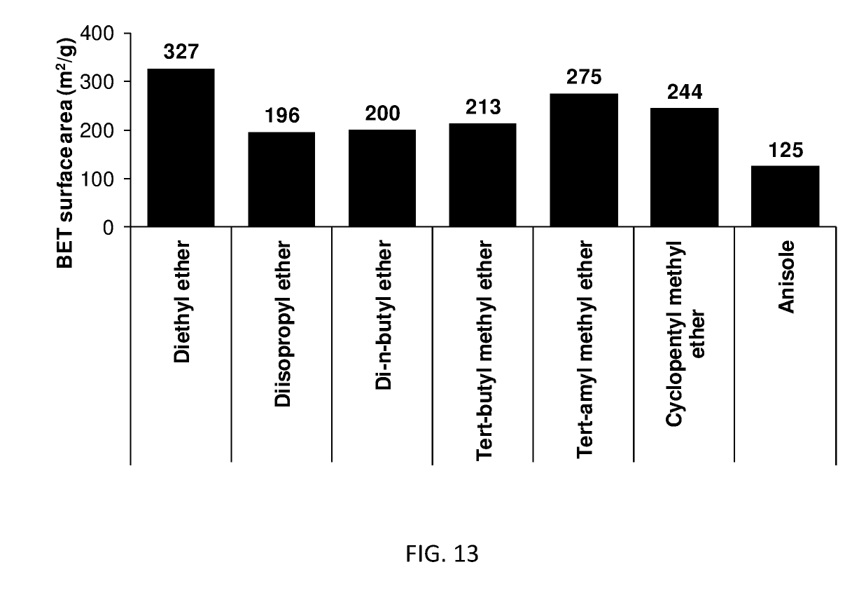

FIG. 13 shows BET surface area of ether treated AIM-LDHs of the invention.

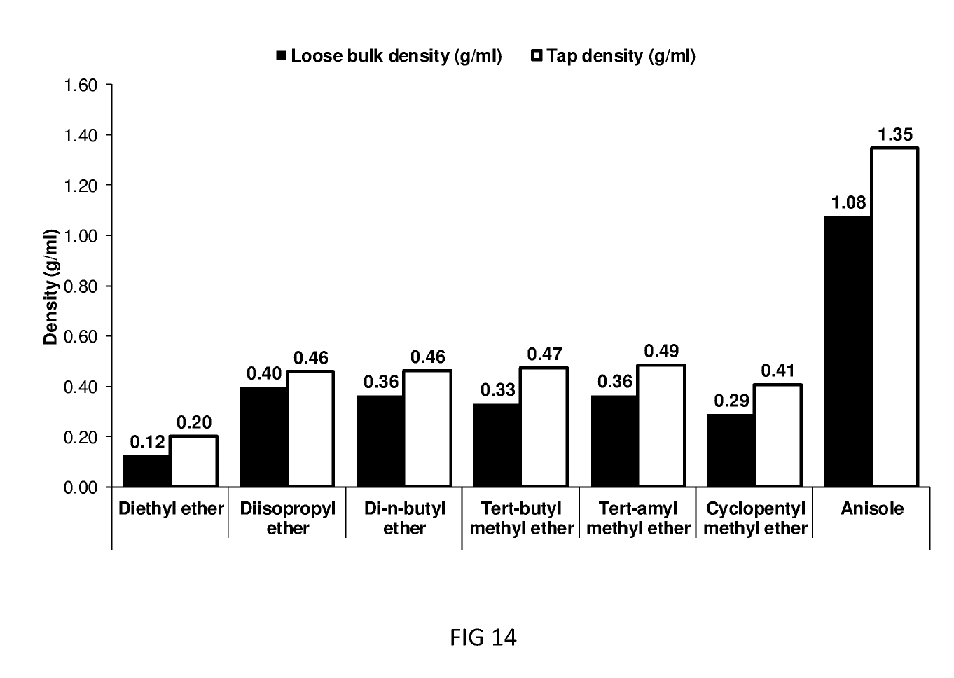

FIG. 14 shows loose bulk and tap densities of ether treated AIM-LDHs of the invention.

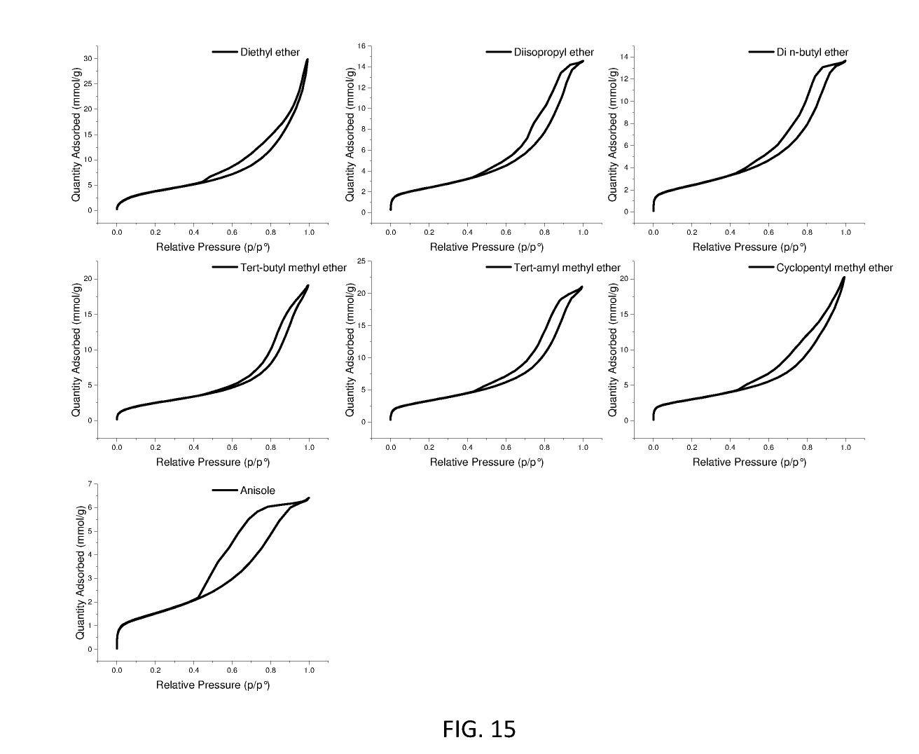

FIG. 15 shows BET isotherm of ether treated AIM-LDHs of the invention.

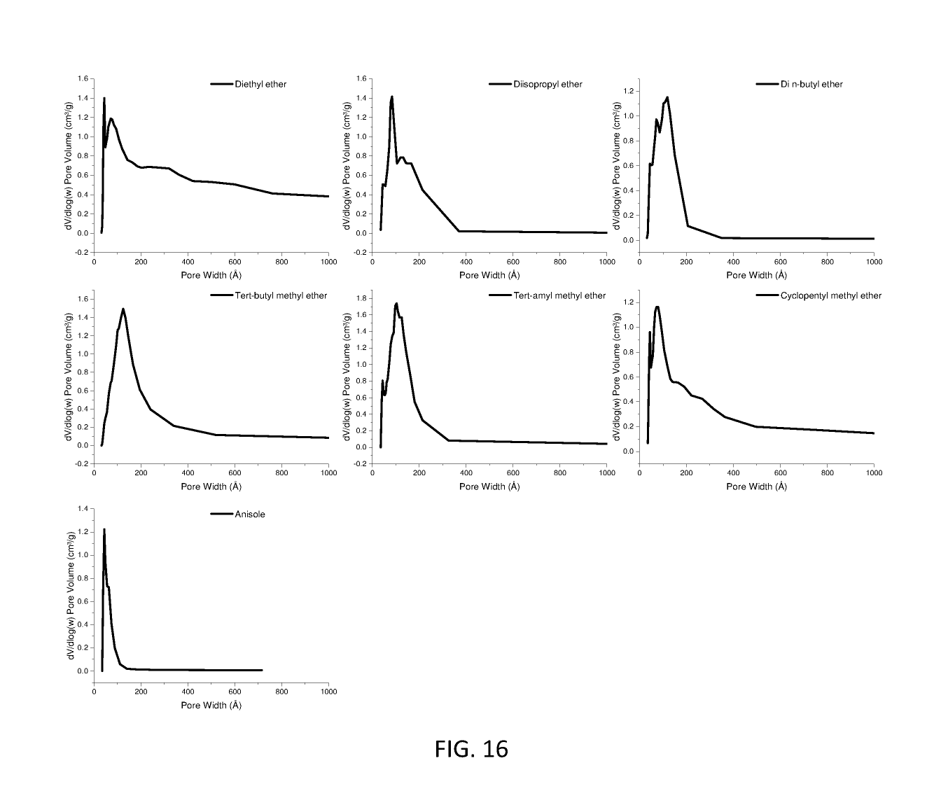

FIG. 16 shows pore size distribution of ether treated AIM-LDHs of the invention.

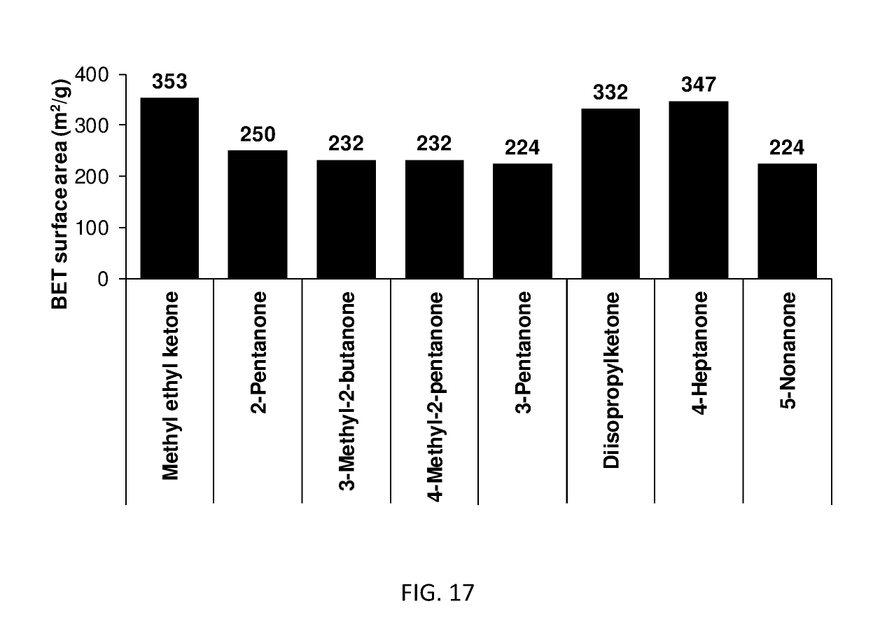

FIG. 17 shows BET surface area of ketone treated AIM-LDHs of the invention.

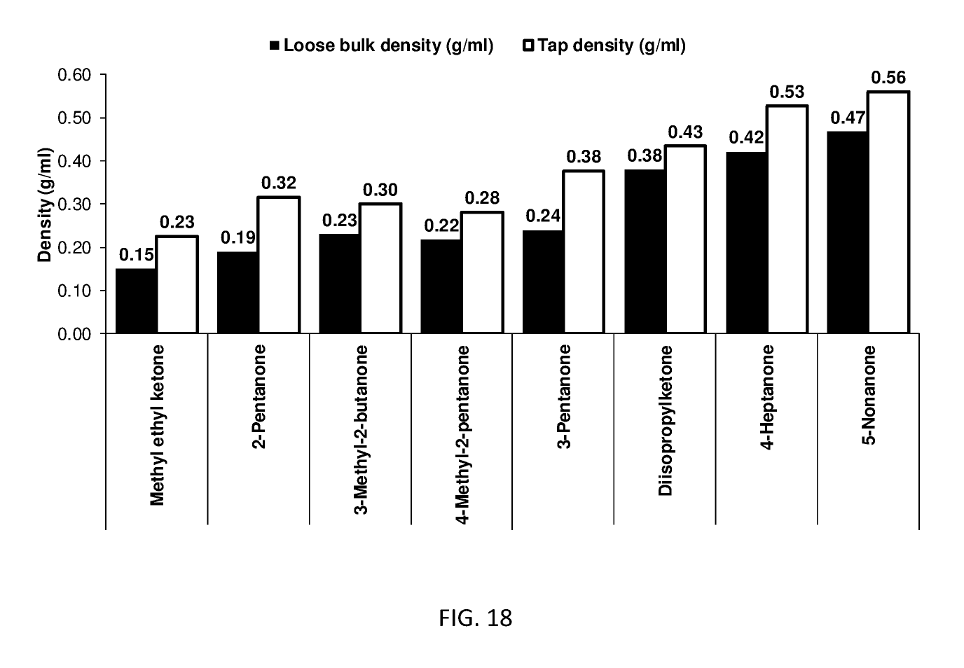

FIG. 18 shows loose bulk and tap densities of ketone treated AIM-LDHs of the invention.

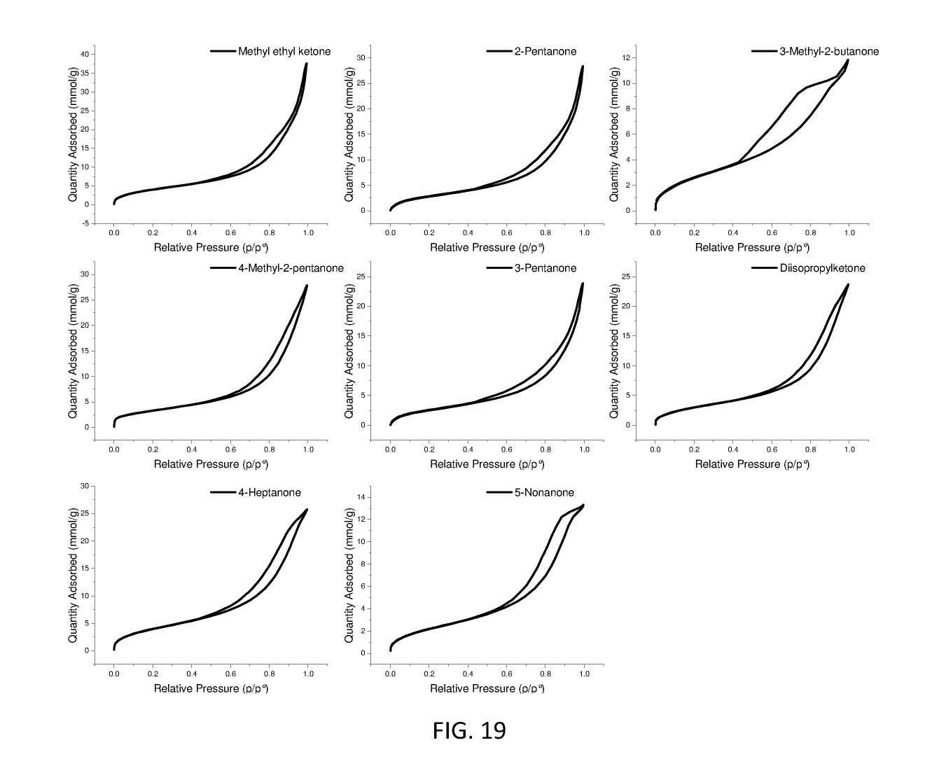

FIG. 19 shows BET isotherm of ketone treated AIM-LDHs of the invention.

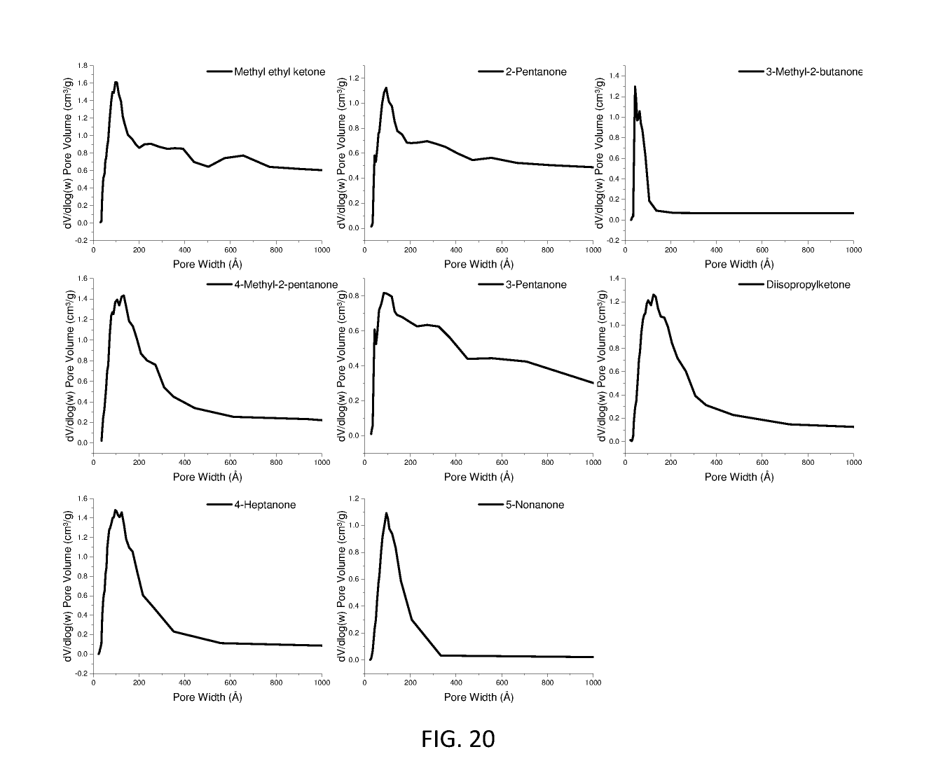

FIG. 20 shows pore size distribution of ketone treated AIM-LDHs of the invention.

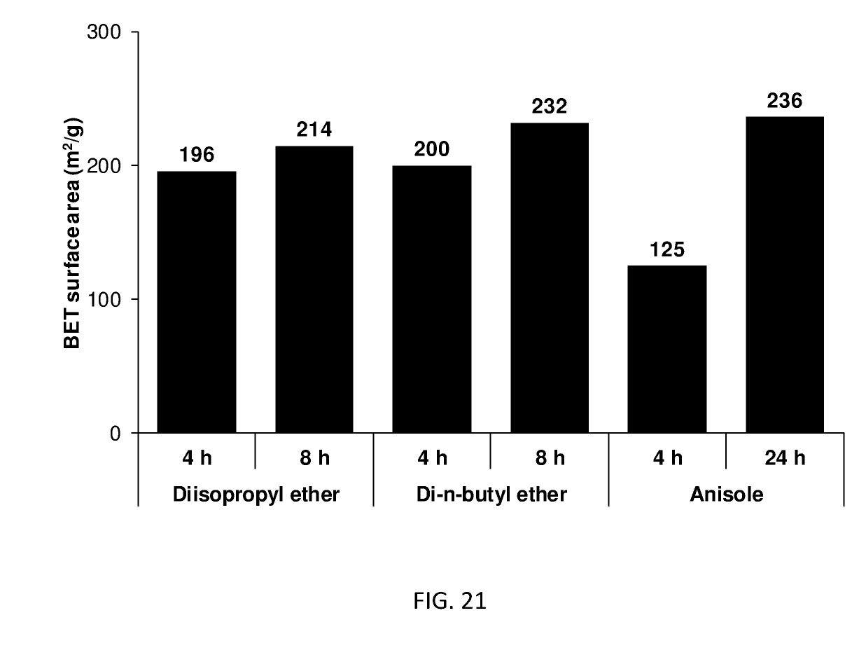

FIG. 21 shows BET surface area of ether treated AIM-LDHs of the invention with varied dispersion time.

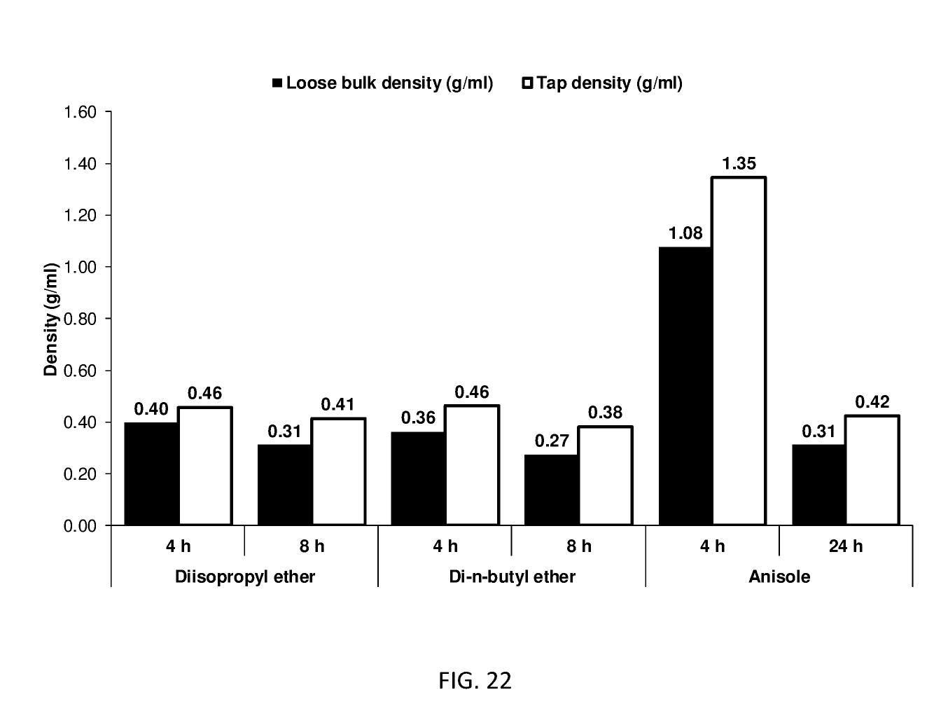

FIG. 22 shows loose bulk and tap densities of ether treated AIM-LDHs of the invention with varied dispersion time.

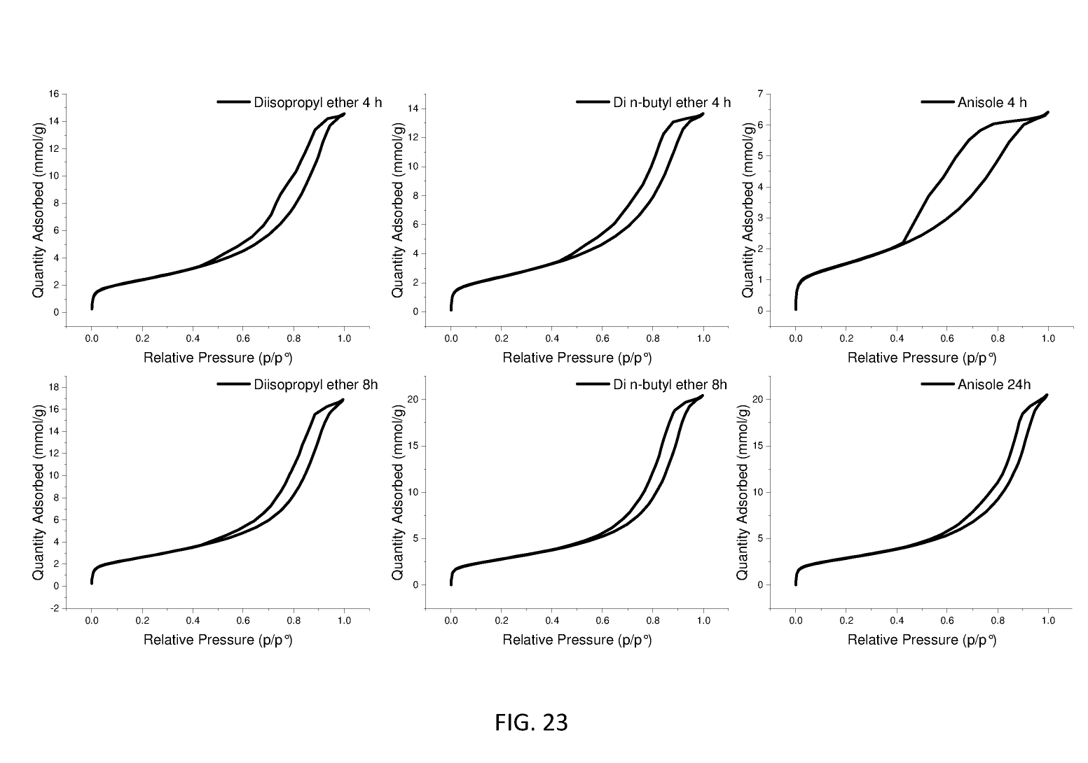

FIG. 23 shows BET isotherm of ether treated AIM-LDHs of the invention with varied dispersion time.

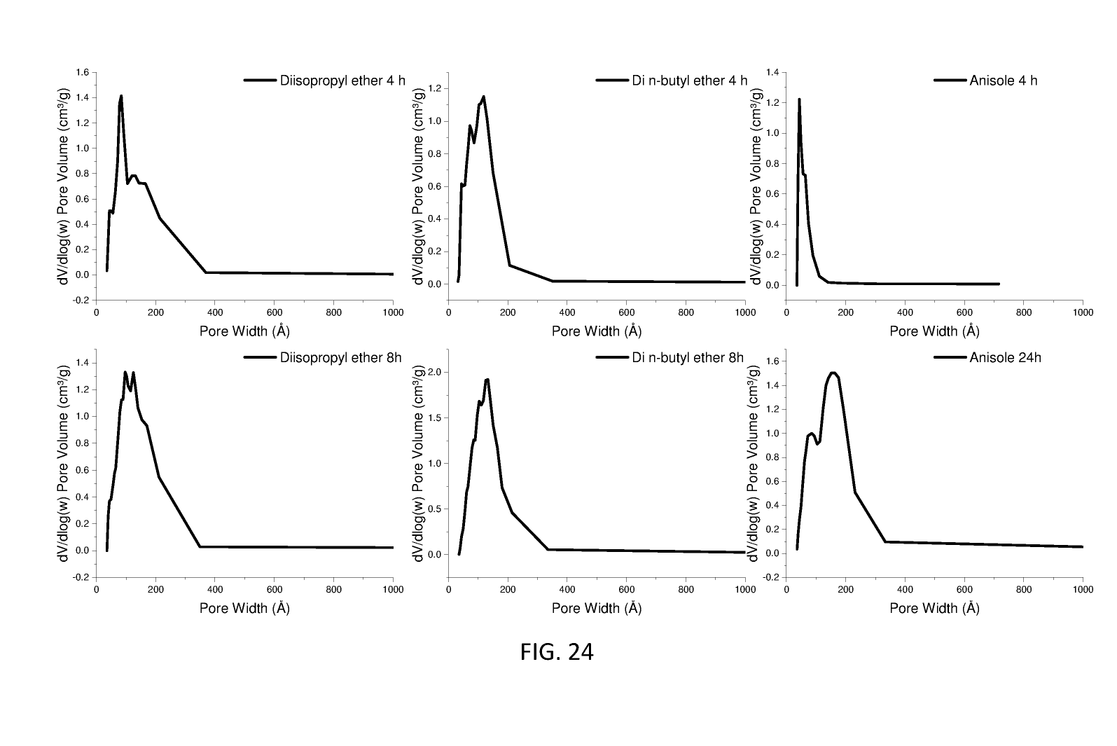

FIG. 24 shows pore size distribution of ether treated AIM-LDHs of the invention with varied dispersion time.

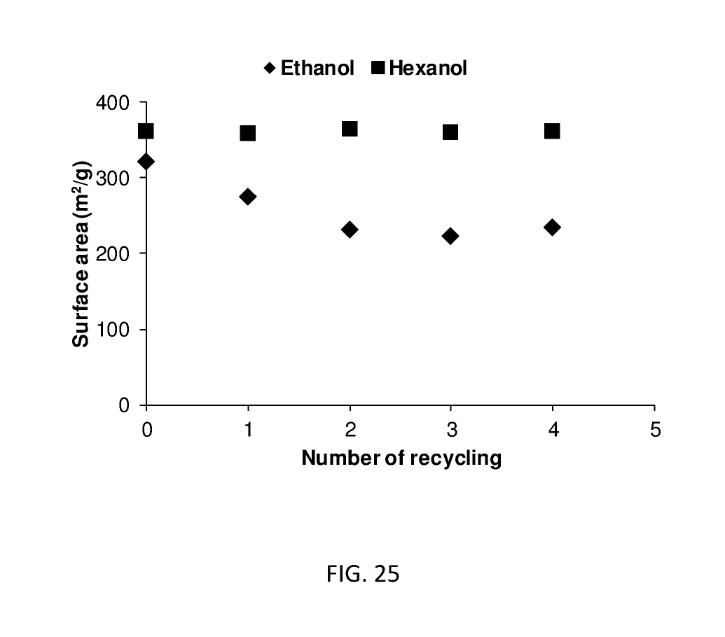

FIG. 25 shows BET surface area of ethanol treated AMO-LDHs and hexanol treated AIM-LDHs of the invention after treatment with solvent that has been recycled n number of times.

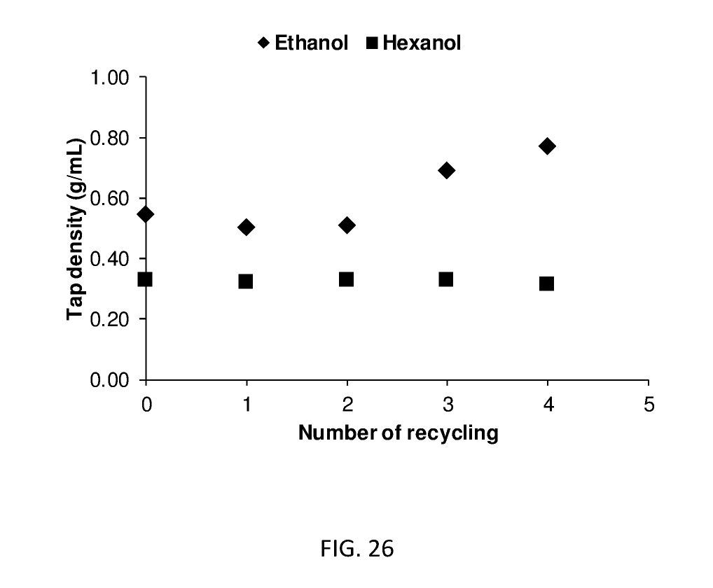

FIG. 26 shows tap densities of ethanol treated AMO-LDHs and hexanol treated AIM-LDHs of the invention after treatment with solvent that has been recycled n number of times.

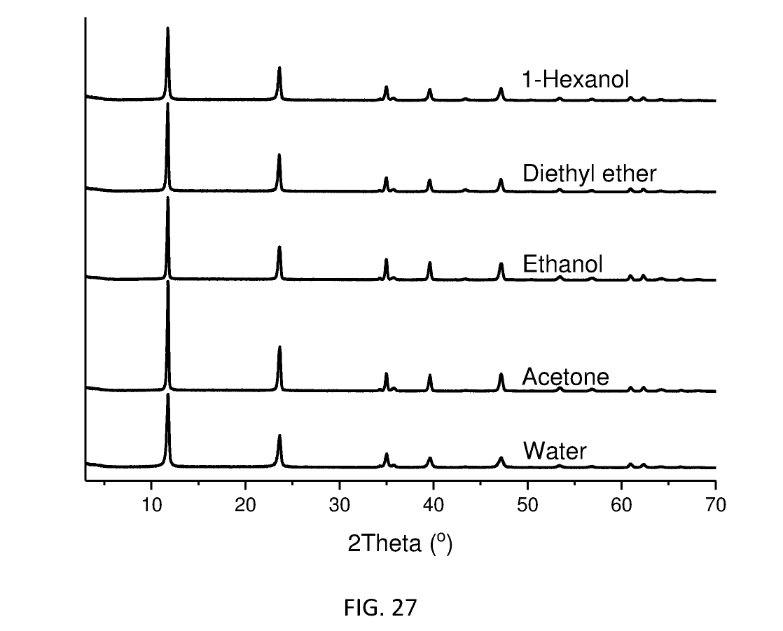

FIG. 27 shows XRD patterns of various platelet LDHs after treatment with different solvents.

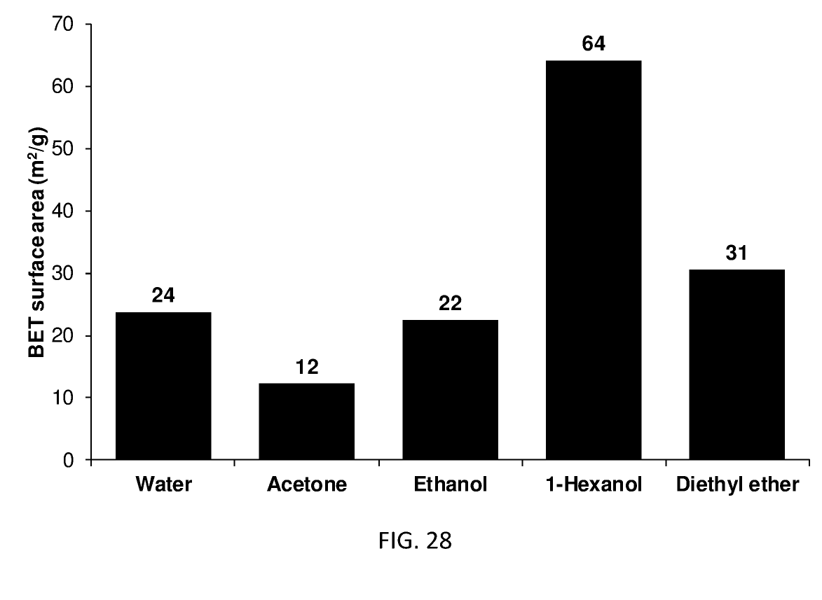

FIG. 28 shows BET surface area of various platelet LDHs after treatment with different solvents.

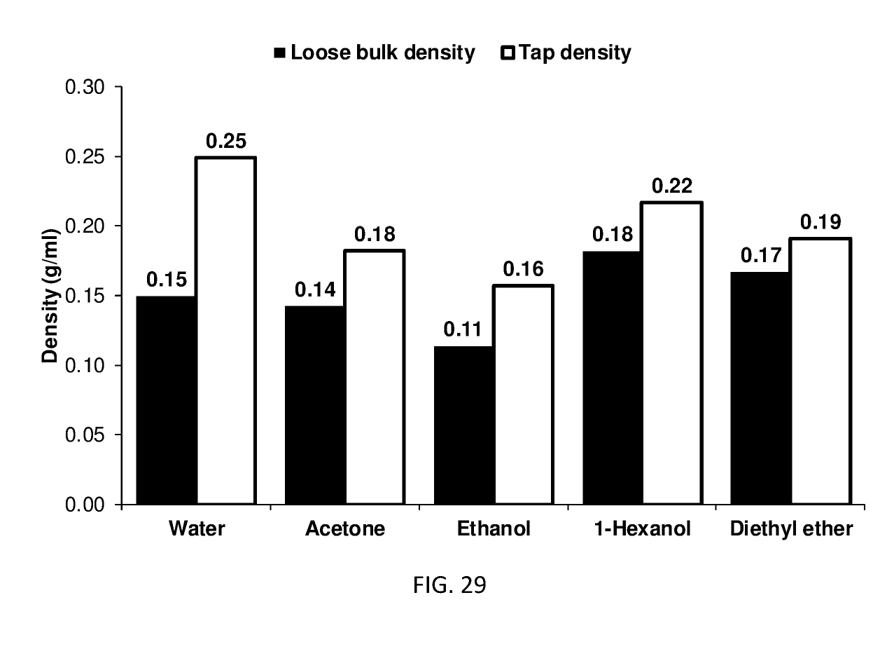

FIG. 29 shows loose bulk and tap densities of various platelet LDHs after treatment with different solvents.

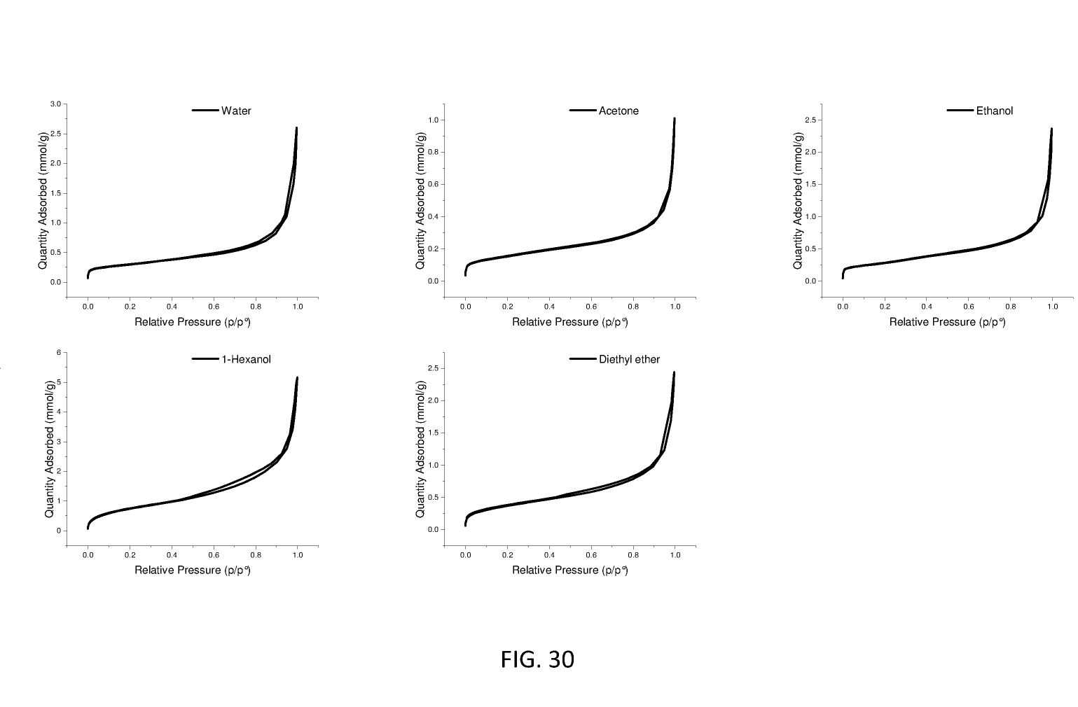

FIG. 30 shows BET isotherm of various platelet LDHs after treatment with different solvents

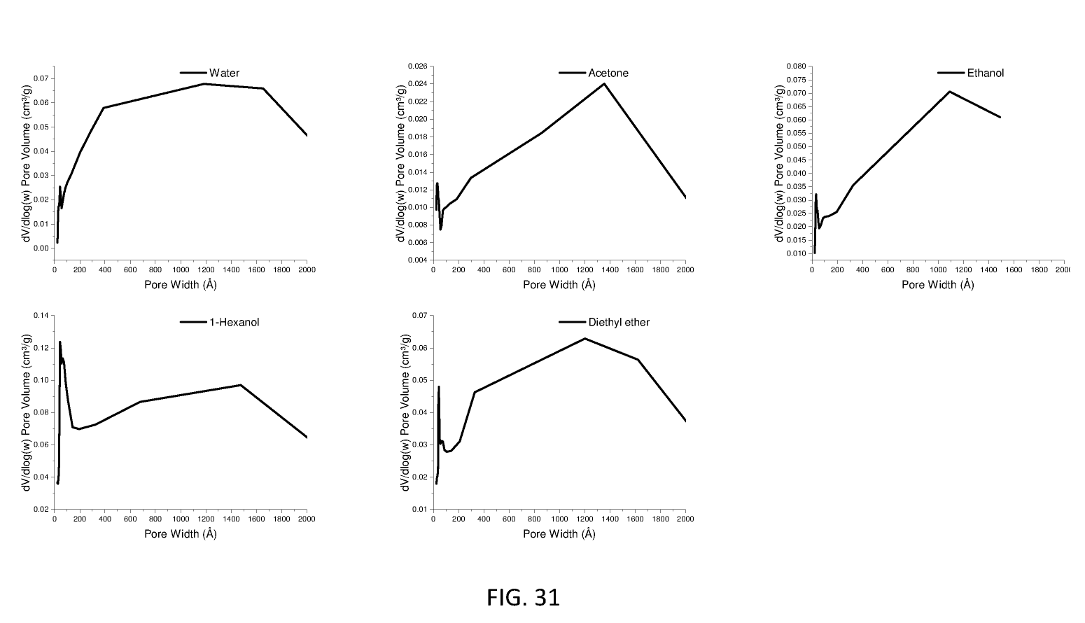

FIG. 31 shows pore size distribution of various platelet LDHs after treatment with different solvents.

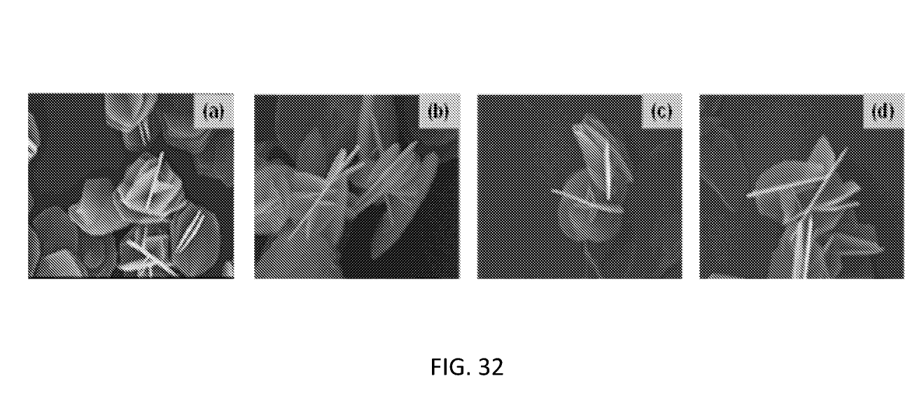

FIG. 32 shows SEM images of various platelet-like LDHs. (a) conventional LDH; (b) acetone treated LDH; (c) ethanol treated LDH; (d) diethyl ether treated LDH of the invention.

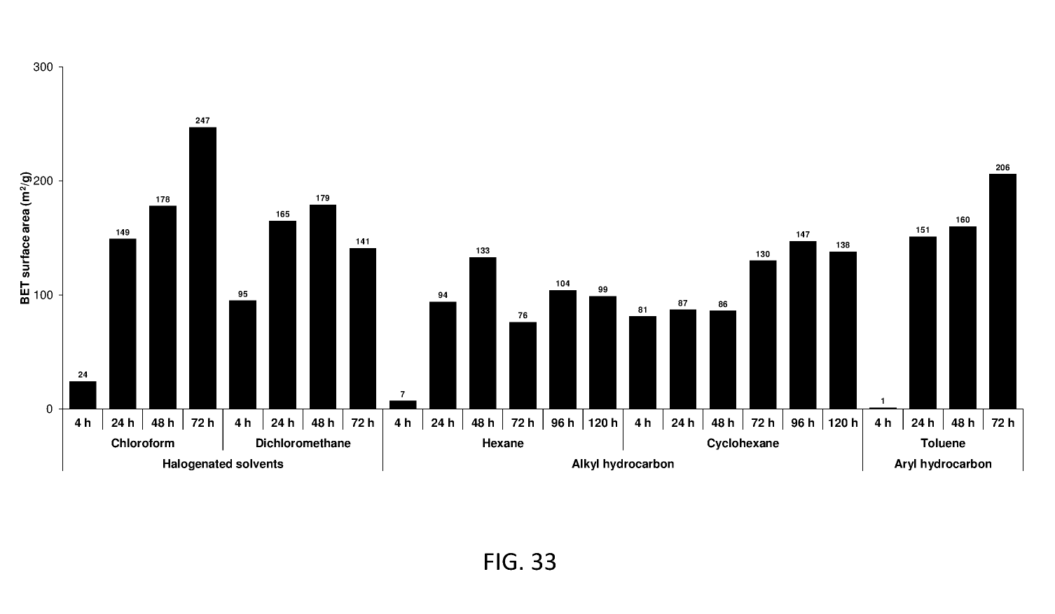

FIG. 33 shows BET surface area of weak hydrogen bonding solvent-washed comparative LDHs with varied dispersion time.

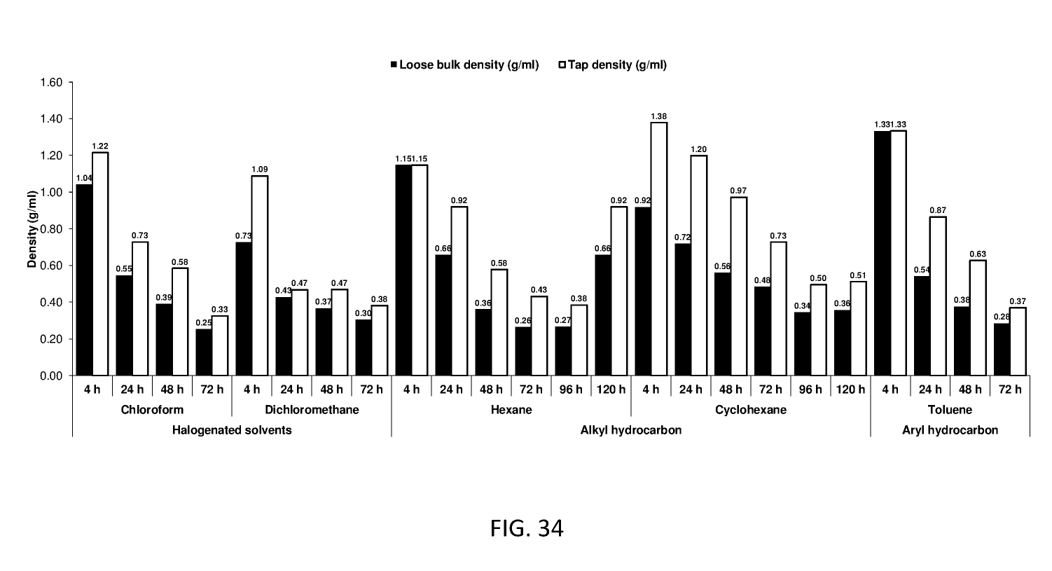

FIG. 34 shows loose bulk and tap densities of weak hydrogen bonding solvent-washed comparative LDHs with varied dispersion time.

### Materials and Methods

X-ray diffraction (XRD) patterns were recorded on a PANalytical X′Pert Pro instrument in reflection mode with Cu Ka radiation. The accelerating voltage was set at 40 kV with 40 mA current (λ=1.542°) at 0.01° s⁻¹ from 1° to 70° with a slit size of ¼ degree.

Transmission electron microscopy (TEM) analysis was performed on JEOL 2100 microscope with an accelerating voltage of 400 kV. Samples were dispersed in ethanol with sonication and then cast onto copper TEM grids coated with lacey carbon film.

Scanning electron microscopy (SEM) analyses were performed on a JEOL JSM 6100 scanning microscope with an accelerating voltage of 20 kV. Powder samples were spread on carbon tape adhered to an SEM stage. Before observation, the samples were sputter coated with a thick Platinum layer to prevent charging and to improve the image quality.

Brunauer-Emmett-Teller (BET) specific surface areas were measured from the N₂ adsorption and desorption isotherms at 77 K collected from a Quantachrome Autosorb-6B surface area and pore size analyser. Before each measurement, LDH samples were first degassed overnight at 110° C.

Brunauer-Emmett-Teller (BET) pore size distributions and pore volumes were calculated from the desorption isotherm.

Thermal gravimetric analyses (TGA) were carried out using a Perkin Elmer TGA7 Thermogravametric Analyser. Approximately 10 mg of sample was heated in a platinum pan in the furnace. Initially the temperature was held at 30° C. for 5 minutes and then was increased to 800° C. at a rate of 5° C. per minute. The sample was held at 800° C. for five minutes. These data were used to determine both the thermal stability and the H₂O and AMO solvent content of the materials. Small variations in the H₂O and acetone content was observed on repeat measurements.

The loose bulk and tap densities were measured by standard testing method (ASTM D7481-09) using a graduated cylinder. The powder was filled into a cylinder and a precise weight of sample (m) was measured. The volume was measured before (V₀) and after 1000 taps (Vₜ). The loose bulk and tap densities were calculated by: Loose bulk density=m/V0; Tap density=m/Vₜ.

### Part A

### Example 1—Synthesis of LDHs

### LDHs of the Invention (“AIM-LDHs”)

An aqueous solution (50 mL) of 0.80 M Mg(NO₃)₂.6H₂O and 0.20 M of Al(NO₃)₃.9H₂O was added drop-wise into a 50 mL of 0.5 M Na₂CO₃ solution with stirring and the pH was controlled at 10 using 4.0 M NaOH solution. After stirring at room temperature for 24 hours, the product was filtered and washed with DI water until the pH was close to 7. Then the wet cake was re-dispersed in 100 mL of DI water. The 25 mL of dispersion was filtered to remove water. The wet cake was rinsed with 500 mL of an AIM-solvent then re-dispersed and stirred in 300 mL of this solvent at room temperature for 4 hours. The AIM-solvent was removed by filtration and the obtained LDHs was further rinsed by 200 mL of this solvent. The product was dried in the vacuum oven overnight. The AIM-solvents used were; diethyl ether, 1-butanol, 1-hexanol, methyl ethyl ketone (MEK), methyl tert-butyl ether (MTBE), nitromethane and triethylamine.

The various LDHs of the invention are identified in Tables 1-6 and FIGS. 1-10 by the particular AIM-solvent used in the synthesis (e.g. “diethyl ether”).

### Comparator LDHs

Various comparator LDHs were prepared by an identical synthesis to that described in respect of the LDHs of the invention, except that the an aqueous immiscible non-hydrogen-bonding solvent (i.e. no hydrogen bond donor or acceptor groups) was used instead of the AIM-solvent. The aqueous immiscible non-hydrogen-bonding solvents used were toluene, hexane and chloroform.

The various comparator LDHs of the invention are identified in FIGS. 1, 5 and 7-9 by the particular aqueous immiscible non-hydrogen-bonding solvent used in the synthesis (e.g. “toluene”).

Conventional LDH (“c-LDH”)

Another comparator LDH was prepared according to a conventional synthesis employing simple water-washing, and without any post-synthesis solvent treatment step. The conventional LDH was prepared by the following protocol: an aqueous solution (50 mL) of 0.80 M Mg(NO₃)₂.6H₂O and 0.20 M of Al(NO₃)₃.9H₂O was added drop-wise into a 50 mL of 0.5 M Na₂CO₃ solution with stirring and the pH was controlled at 10 using 4.0 M NaOH solution. After stirring at room temperature for 24 hours, the product was filtered and washed with DI water until the pH was close to 7. (The product was filtered to remove water and dried in vacuum oven overnight.).

The conventional LDH is denoted “water” in Tables 2-6 and FIGS. 1, 3-5 and 6-10.

### Example 2—Characterisation of LDHs

### XRD

FIG. 1 shows the XRD patterns of various LDHs of the invention, as well as that of conventional LDH and various other comparator LDHs. The various traces are identical, suggesting that the LDH structure of the conventionally-prepared sample (without AIM-solvent treatment) is preserved when subjected to the AIM-solvent treatment step forming part of the invention.

Table 1 below and FIG. 2 show XRD data for a variety of LDHs of the invention, each of which has been prepared using a different amount of diethyl ether as AIM-solvent in the AIM-solvent dispersion step of Example 1.

TABLE 1
XRD data for diethyl ether-treated LDHs of the invention

| | | | | Mean | | | | |
|---|---|---|---|---|---|---|---|---|
| | | | | crystallite | | | | |
| | Rinsing | d-spacing | | domain lengths | | Unit cell | | No. |
| | volume | d003 | d110 | D003 | D110 | parameter | | of |
| Solvent | (mL) | (Å) | (Å) | (Å) | (Å) | a | c | layers |
| Diethyl | 100 mL | 7.73 | 1.52 | 59.5 | 92.8 | 3.05 | 23.18 | 8 |
| ether | 300 mL | 7.68 | 1.52 | 64.7 | 87.7 | 3.05 | 23.05 | 8 |
| | 500 mL | 7.69 | 1.52 | 54.0 | 83.7 | 3.05 | 23.08 | 7 |
| | 1000 mL | 7.73 | 1.52 | 60.4 | 92.9 | 3.05 | 23.19 | 8 |

The various traces presented in FIG. 2 are identical to one another, suggesting that the structure of the LDHs of the invention can tolerate various quantities of AIM-solvent in the dispersion step of Example 1.

### TGA

Table 2 below and FIGS. 3-4 illustrate the thermal properties of various LDHs of the invention, as well as those of a conventional LDH.

TABLE 2
Thermal properties of conventional LDH and LDHs of
the invention

| | | Change | | Change |
|---|---|---|---|---|
| Washing | T₀ | w.r.t water | T₁ | w.r.t water |
| solvent | (° C.) | (° C.) | (° C.) | (° C.) |
| Water | 110 | — | 179 | — |
| 1-Hexanol | 103 | −7 | 171 | −9 |
| Diethyl ether | 102 | — | 163 | −16 |

Having regard to Table 2 and FIGS. 3-4, the mass loss at T₀ is indicative of the AIM-solvent being lost from the LDH structure. At T₁, water is lost from the LDH structure.

The mass loss data provided in Table 2 and FIGS. 3-4 allows for full characterisation of the composition of the LDH structure. In particular the TGA data allows the values of b (quantity of water) and c (quantity of AIM-solvent) in the LDHs of the invention to be determined. In some cases, elemental analysis was used to determine the values of b and c. Table 3 below summarises the compositional LDH data determined through TGA analysis.

TABLE 3
Compositional data for conventional LDH and LDHs of the invention

| Washing solvent | b | c | Formula of LDH |
|---|---|---|---|
| Water | 0.63 | 0.00 | Mg_{0.8}Al_{0.2}(OH)₂](CO₃)_{0.1}•0.63H₂O |
| 1-Hexanol | 0.63 | 0.06 | Mg_{0.8}Al_{0.2}(OH)₂](CO₃)_{0.1}•0.63H₂O•0.06(1-hexanol) |
| Diethyl ether | 0.54 | 0.08 | Mg_{0.8}Al_{0.2}(OH)₂](CO₃)_{0.1}•0.54H₂O•0.08(diethyl ether) |

### Example 3—Surface Area and Pore Volume Studies

Table 4 below shows BET surface area properties for a variety of LDHs of the invention, as well as those for conventional LDH.

TABLE 4
BET surface area properties of LDHs

| | Surface area (m²/g) | | | |
|---|---|---|---|---|
| Washing | | % | Deaggregation | |
| solvent | Value | Change | factor* | Formula of LDH |
| Water | 9 | — | — | Mg_{0.8}Al_{0.2}(OH)₂](CO₃)_{0.1}•0.63H₂O |
| 1- | 364 | 3944 | 40 | Mg_{0.8}Al_{0.2}(OH)₂](CO₃)_{0.1}•0.63H₂O•0.06(1- |
| Hexanol | | | | hexanol) |
| Diethyl | 327 | 3533 | 36 | Mg_{0.8}Al_{0.2}(OH)₂](CO₃)_{0.1}•0.54H₂O•0.08(diethyl |
| ether | | | | ether) |
| Nitro | 331 | 3578 | 37 | — |
| methane | | | | |
| Triethyl | 363 | 3933 | 40 | — |
| amine | | | | |

*Deaggregation factor = BET surface area/BET surface area of equivalent water-washed LDH.

FIG. 5 compares the BET surface area properties of various LDHs of the invention with those of conventional LDH and other comparator LDHs. The data presented in Table 4 and FIG. 5 demonstrate that the LDHs of the invention have vastly superior BET surface area properties when compared with conventionally-prepared LDH or LDHs treated with aqueous immiscible solvents that do not have hydrogen bonding characteristics.

FIG. 6 provides BET surface area data for two different LDHs of the invention, each of which has been prepared using a different amount of diethyl ether as AIM-solvent in the AIM-solvent dispersion step of Example 1. The data suggest that greater surface area correlates with an increased amount of AIM-solvent in the AIM-solvent dispersion step of Example 1.

FIG. 7 provides BET data curves for various LDHs of the invention with those of conventional LDH and other comparator LDHs.

Table 5 below shows BET pore volume properties for a variety of LDHs of the invention, as well as those for conventional LDH.

TABLE 5
BET pore volume properties of LDHs

| | Pore volume | | |
|---|---|---|---|
| | (cc/g) | | |
| Washing | | % | |
| solvent | Value | Change | Formula of LDHs |
| Water | 0.01 | — | Mg_{0.8}Al_{0.2}(OH)₂](CO₃)_{0.1}•0.63H₂O |
| 1-Hexanol | 1.02 | 10100 | Mg_{0.8}Al_{0.2}(OH)₂](CO₃)_{0.1}•0.63H₂O•0.06(1-hexanol) |
| Diethyl ether | 1.02 | 10100 | Mg_{0.8}Al_{0.2}(OH)₂](CO₃)_{0.1}•0.54H₂O•0.08(diethyl ether) |
| Nitromethane | 1.33 | 13200 | — |
| Triethylamine | 1.1 | 10900 | — |

FIG. 8 provides pore volume data for various LDHs of the invention with those of conventional LDH and other comparator LDHs. The data demonstrate that the LDHs of the invention have significantly greater pore volumes than conventional LDH and those LDHs treated with aqueous immiscible solvents that do not have hydrogen bonding characteristics.

### Example 4—Density Studies

Table 6 below provides density properties for a variety of LDHs of the invention, as well as those for conventional LDH.

TABLE 6
Density properties of LDHs

| | Loose | | | | |
|---|---|---|---|---|---|
| | bulk | | Tap | | |
| | density | | density | | |
| | (g/ml) | | (g/ml) | | |
| Washing | | % | | % | |
| solvent | Value | Change | Value | Change | Formula of LDHs |
| Water | 1.07 | — | 1.21 | — | Mg_{0.8}Al_{0.2}(OH)₂](CO₃)_{0.1}•0.63H₂O |
| 1-Hexanol | 0.15 | −86 | 0.23 | −81 | Mg_{0.8}Al_{0.2}(OH)₂](CO₃)_{0.1}•0.63H₂O•0.06(1-hexanol) |
| Diethyl | 0.12 | −88 | 0.2 | −83 | Mg_{0.8}Al_{0.2}(OH)₂](CO₃)_{0.1}•0.54H₂O•0.08(diethyl ether) |
| ether | | | | | |
| Nitro | 0.15 | −86 | 0.27 | −78 | — |
| methane | | | | | |
| Triethyl | 0.16 | −85 | 0.22 | −82 | — |
| amine | | | | | |

FIG. 9 compares the density properties of various LDHs of the invention with those of conventional LDH and other comparator LDHs. The data presented in Table 6 and FIG. 9 demonstrate that the LDHs of the invention are much less dense than conventionally-prepared LDH and LDHs treated with aqueous immiscible solvents that do not have hydrogen bonding due to much reduced particle-particle interactions.

FIG. 10 compares tap densities of various LDHs of the invention with those of conventional LDH as a function of the number of taps. FIG. 10 demonstrates that the LDHs of the invention have much lower tap densities than conventionally-prepared LDH.

### Part B

### Example 5—Synthesis of LDHs

LDHs of the invention (“AIM-LDHs”)

An aqueous solution (50 mL) of 0.80 M Mg(NO₃)₂.6H₂O and 0.20 M of Al(NO₃)₃.9H₂O was added drop-wise into a 50 mL of 0.5 M Na₂CO₃ solution with stirring and the pH was controlled at 10 using 4.0 M NaOH solution. After stirring at room temperature for 24 hours, the product was filtered and washed with DI water until the pH was close to 7. Then the wet cake was re-dispersed in 100 mL of DI water. The 25 mL of dispersion was filtered to remove water. The wet cake was rinsed with 500 mL of an AIM-solvent then re-dispersed and stirred in 300 mL of this solvent at room temperature for 4 hours. The AIM-solvent was removed by filtration and the obtained LDHs was further rinsed by 200 mL of this solvent. The product was dried in the vacuum oven overnight. The AIM-solvents used were; diethyl ether, methyl ethyl ketone (MEK) (butanone), 1-hexanol, 1-butanol, nitromethane, trimethylamine, methyl tert-butyl ether (MTBE), tert-amyl methyl ether, cyclopentyl methyl ether, anisole, diisopropyl ether, di-n-butyl ether, 2-pentanone, 3-methyl-2-butanone, 4-methyl-2-pentanone, 3-pentanone, 2,4-dimethyl-3-pentanone, 4-heptanone and 5-nonanone.

### Comparator LDHs (Aqueous Immiscible Weakly/Non-Hydrogen-Bonding Solvent)

Various comparator LDHs were prepared by an identical synthesis to that described in respect of the LDHs of the invention, except that the an aqueous immiscible weakly-hydrogen-bonding solvent was used instead of the AIM-solvent. The aqueous immiscible weakly-hydrogen-bonding solvents used were toluene, hexane, cyclohexane, dichloromethane and chloroform.

### Comparator LDHs (Aqueous Miscible Hydrogen-Bonding Solvent)

Various comparator LDHs were prepared by an identical synthesis to that described in respect of the LDHs of the invention, except that an aqueous miscible hydrogen-bonding solvent was used instead of the AIM-solvent. The aqueous miscible hydrogen-bonding solvents (termed “AMO solvents”) used were acetone, ethanol, 1-methyl-2-pyrrolidone and isopropyl alcohol. Such comparator LDHs were termed “AMO-LDHs”.

Conventional LDH (“c-LDH”)

Another comparator LDH was prepared according to a conventional synthesis employing simple water-washing, and without any post-synthesis solvent treatment step. The conventional LDH was prepared by the following protocol: an aqueous solution (50 mL) of 0.80 M Mg(NO₃)₂.6H₂O and 0.20 M of Al(NO₃)₃.9H₂O was added drop-wise into a 50 mL of 0.5 M Na₂CO₃ solution with stirring and the pH was controlled at 10 using 4.0 M NaOH solution. After stirring at room temperature for 24 hours, the product was filtered and washed with DI water until the pH was close to 7. (The product was filtered to remove water and dried in vacuum oven overnight.).

Table 7 below shows the water and solvent content of various AIM-LDHs, comparator LDHs and conventional LDHs prepared according to the above-described protocols, as determined by elemental analysis:

TABLE 7
Elemental composition of various AIM-LDHs, comparator LDHs and conventional LDHs

| Washing solvent | | b | c | Formula of LDHs |
|---|---|---|---|---|
| C-LDH | Water | 0.634 | 0.000 | [Mg_{0.80}Al_{0.20}(OH)₂(CO₃)_{0.125}]•0.634H₂O |
| AMO | Acetone | 0.225 | 0.113 | [Mg_{0.80}Al_{0.20}(OH)₂(CO₃)_{0.125}]•0.225H₂O•0.113(Acetone) |
| solvents | 1-Methyl-2- | 0.512 | 0.092 | [Mg_{0.80}Al_{0.20}(OH)₂(CO₃)_{0.125}]•0.512H₂O•0.092(1-Methyl-2-pyrrolidinone) |
| | pyrrolidinone | | | |
| | Ethanol | 0.245 | 0.215 | [Mg_{0.80}Al_{0.20}(OH)₂(CO₃)_{0.125}]•0.245H₂O•0.215(Ethanol) |
| | Isopropyl | 0.033 | 0.109 | [Mg_{0.80}Al_{0.20}(OH)₂(CO₃)_{0.125}]•0.033H₂O•0.109(Isopropylalcohol) |
| | alcohol | | | |
| AIM | 1-Butanol | 0.041 | 0.099 | [Mg_{0.80}Al_{0.20}(OH)₂(CO₃)_{0.125}]•0.041H₂O•0.099(1-Butanol) |
| solvents | 1-Hexanol | 0.110 | 0.087 | [Mg_{0.80}Al_{0.20}(OH)₂(CO₃)_{0.125}]•0.110H₂O•0.087(1-Hexanol) |
| | Diethyl ether | 0.370 | 0.021 | [Mg_{0.80}Al_{0.20}(OH)₂(CO₃)_{0.125}]•0.370H₂O•0.021(Diethyl ether) |
| | 2-Butanone | 0.051 | 0.082 | [Mg_{0.80}Al_{0.20}(OH)₂(CO₃)_{0.125}]•0.051H₂O•0.082(2-Butanone) |
| | Methyl tert- | 0.247 | 0.040 | [Mg_{0.80}Al_{0.20}(OH)₂(CO₃)_{0.125}]•0.247H₂O•0.040(Methyl tert-butyl ether) |
| | butyl ether | | | |
| | Nitromethane | 0.214 | 0.049 | [Mg_{0.80}Al_{0.20}(OH)₂(CO₃)_{0.125}]•0.214H₂O•0.049(Nitromethane) |
| | Triethylamine | 0.124 | 0.036 | [Mg_{0.80}Al_{0.20}(OH)₂(CO₃)_{0.125}]•0.124H₂O•0.036(Triethylamine) |
| Weak H- | Toluene | 0.402 | 0.001 | [Mg_{0.80}Al_{0.20}(OH)₂(CO₃)_{0.125}]•0.402H₂O•0.001(Toluene) |
| bonding | Hexane | 0.548 | 0.002 | [Mg_{0.80}Al_{0.20}(OH)₂(CO₃)_{0.125}]•0.548H₂O•0.002(Hexane) |
| solvents | Chloroform | 0.593 | 0.042 | [Mg_{0.80}Al_{0.20}(OH)₂(CO₃)_{0.125}]•0.593H₂O•0.042(Chloroform) |

### Example 6—Effect of Mg/Al Ratio

To investigate the effect of varying the Mg/Al cation ratio within the LDH, the general synthetic protocols outlined at Example 5 were adapted to prepare a series of AIM-LDHs (wherein the AIM solvent is diethyl ether), a series of AMO-LDHs (wherein the AMO solvent is acetone or ethanol) and a series of c-LDHs having Mg/Al cationic ratios of 2, 3 and 4.

Table 8 below shows the water and solvent content of the various LDHs prepared in Example 6, as determined by elemental analysis.

TABLE 8
Elemental composition of AIM-LDHs, AMO-LDHs and c-LDHs having varying Mg/Al ratios

| LDH with | | | | |
|---|---|---|---|---|
| Mg/Al ratio | Solvents | b | c | Formula of LDHs |
| Mg/Al = 2 | Water | 0.415 | 0.000 | [Mg_{0.67}Al_{0.33}(OH)₂(CO₃)_{0.125}]•0.415H₂O |
| | Acetone | 0.081 | 0.074 | [Mg_{0.67}Al_{0.33}(OH)₂(CO₃)_{0.125}]•0.081 H₂O•0.074(Acetone) |
| | Diethyl ether | 0.246 | 0.044 | [Mg_{0.67}Al_{0.33}(OH)₂(CO₃)_{0.125}]•0.246H₂O•0.044(Diethyl |
| | | | | ether) |
| Mg/Al = 3 | Water | 0.461 | 0.000 | [Mg_{0.75}Al_{0.25}(OH)₂(CO₃)_{0.125}]•0.461 H₂O |
| | Acetone | 0.248 | 0.067 | [Mg_{0.75}Al_{0.25}(OH)₂(CO₃)_{0.125}]•0.248H₂O•0.067(Acetone) |
| | Ethanol | 0.396 | 0.176 | [Mg_{0.75}Al_{0.25}(OH)₂(CO₃)_{0.125}]•0.396H₂O•0.176(Ethanol) |
| | Diethyl ether | 0.182 | 0.086 | [Mg_{0.75}Al_{0.25}(OH)₂(CO₃)_{0.125}]•0.182H₂O•0.086(Diethyl |
| | | | | ether) |
| Mg/Al = 4 | Water | 0.634 | 0.000 | [Mg_{0.80}Al_{0.20}(OH)₂(CO₃)_{0.125}]•0.634H₂O |
| | Acetone | 0.225 | 0.113 | [Mg_{0.80}Al_{0.20}(OH)₂(CO₃)_{0.125}]•0.225H₂O•0.113(Acetone) |
| | Ethanol | 0.245 | 0.215 | [Mg_{0.80}Al_{0.20}(OH)₂(CO₃)_{0.125}]•0.245H₂O•0.215(Ethanol) |
| | Diethyl ether | 0.370 | 0.021 | [Mg_{0.80}Al_{0.20}(OH)₂(CO₃)_{0.125}]•0.370H₂O•0.021 (Diethyl |
| | | | | ether) |

Table 9 below shows cell data for various LDHs prepared in Example 6.

TABLE 9
Mean crystallite domain lengths and unit cell parameters
of AIM-LDHs and c-LDHs with different ratios of Mg/Al

| | Washing | d003 | D003 | No. of | d110 | | |
|---|---|---|---|---|---|---|---|
| Mg/Al ratio | solvent | (Å) | (Å) | layers | (Å) | a | c |
| 2 | Water | 7.52 | 147.5 | 20 | 1.48 | 2.96 | 22.56 |
| | Diethyl ether | 7.63 | 33.7 | 4 | 1.52 | 3.03 | 22.89 |
| 3 | Water | 7.62 | 107.3 | 14 | 1.53 | 3.05 | 22.87 |
| | Diethyl ether | 7.73 | 36.6 | 5 | 1.52 | 3.04 | 23.2 |
| 4 | Water | 7.53 | 262.8 | 35 | 1.52 | 3.05 | 22.58 |
| | Diethyl ether | 7.75 | 40.8 | 5 | 1.53 | 3.05 | 23.25 |

FIG. 11 shows the XRD patters of the AIM-LDHs and c-LDHs presented in Table 9. Table 9 and FIG. 11 demonstrate that the cationic ratio does not have a significant effect on the unit cell parameters of the LDH.

FIG. 12 shows BET surface area data for the AIM-LDHs and c-LDHs presented in Table 9. FIG. 12 demonstrates that the AIM-LDHs have a vastly superior surface area to the c-LDHs, but that the cationic ratio does not have a significant effect on surface area.

### Example 7—Effect of Solvent Structure

The effect of AIM solvent structure on the properties of the AIM-LDH (BET surface area, density, pore volume and pore size distribution) was investigated. A series of ether solvents and ketone solvents were studied.

For the ether AIM solvents having the general structure R₁—O—R₂, AIM-LDHs were prepared (according to the general protocol of Example 5) using the following solvents:

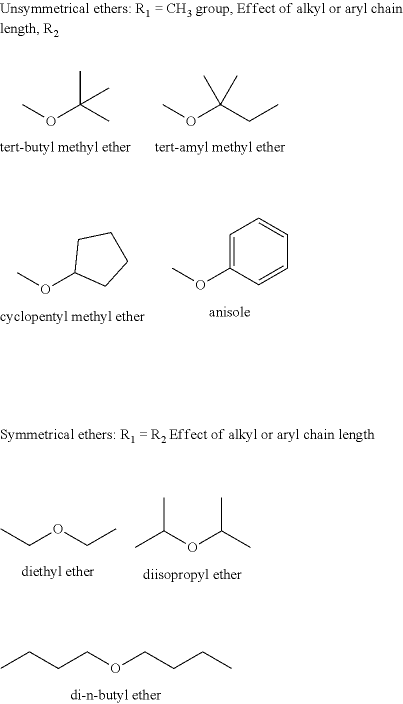

Table 10 below shows the water and solvent content of these ether AIM-LDHs, as determined by elemental analysis.

TABLE 10
Elemental composition of ether AIM-LDHs

| Ether solvents | | b | c | Formula of LDHs |
|---|---|---|---|---|
| R1═CH3 | Diethyl ether | 0.370 | 0.021 | [Mg_{0.80}Al_{0.20}(OH)₂(CO₃)_{0.125}]•0.370H₂O•0.021(Diethyl ether) |
| group | Diisopropyl | 0.525 | 0.012 | [Mg_{0.80}Al_{0.20}(OH)₂(CO₃)_{0.125}]•0.525H₂O•0.012(Diisopropyl ether) |
| | ether | | | |
| | Di-n-butyl | 0.630 | 0.013 | [Mg_{0.80}Al_{0.20}(OH)₂(CO₃)_{0.125}]•0.630H₂O•0.013(Di-n-butyl ether) |
| | ether | | | |
| R1═R2 | Methyl tert- | 0.247 | 0.040 | [Mg_{0.80}Al_{0.20}(OH)₂(CO₃)_{0.125}]•0.247H₂O•0.040(Methyl tert-butyl ether) |
| | butyl ether | | | |
| | Tert-amyl | 0.503 | 0.016 | [Mg_{0.80}Al_{0.20}(OH)₂(CO₃)_{0.125}]•0.503H₂O•0.016(Tert-amyl methyl ether) |
| | methyl ether | | | |
| | Cyclopentyl | 0.490 | 0.011 | [Mg_{0.80}Al_{0.20}(OH)₂(CO₃)_{0.125}]•0.490H₂O•0.011(Cyclopentyl methyl ether) |
| | methyl ether | | | |
| | Anisole | 0.506 | 0.007 | [Mg_{0.80}Al_{0.20}(OH)₂(CO₃)_{0.125}]•0.506H₂O•0.007(Anisole) |

For the ketone AIM solvents having the general structure R₁—C(O)—R₂, AIM-LDHs were prepared (according to the general protocol of Example 5) using the following solvents:

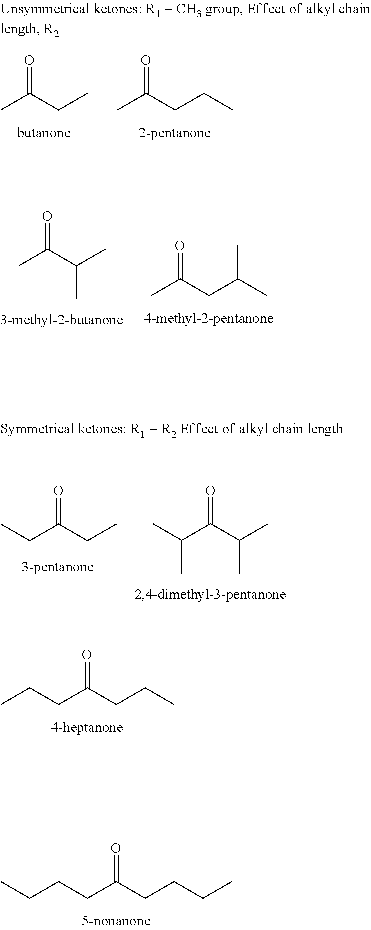

Table 11 below shows the water and solvent content of these ketone AIM-LDHs, as determined by elemental analysis.

TABLE 11
Elemental composition of ketone AIM-LDHs

| Ketone solvents | | b | c | Formula of LDHs |
|---|---|---|---|---|
| R1═CH3 | 2-Butanone | 0.051 | 0.082 | [Mg_{0.80}Al_{0.20}(OH)₂(CO₃)_{0.125}]•0.051H₂O•0.082(2-Butanone) |
| group | 2-Pentanone | 0.130 | 0.302 | [Mg_{0.80}Al_{0.20}(OH)₂(CO₃)_{0.125}]•0.130H₂O•0.302(2-Pentanone) |
| | 3-Methyl-2- | 0.431 | 0.136 | [Mg_{0.80}Al_{0.20}(OH)₂(CO₃)_{0.125}]•0.431H₂O•0.136(3-Methyl-2-butanone) |
| | butanone | | | |
| | 4-Methyl-2- | 0.564 | 0.049 | [Mg_{0.80}Al_{0.20}(OH)₂(CO₃)_{0.125}]•0.564H₂O•0.049(4-Methyl-2-pentanone) |
| | pentanone | | | |
| R1═R2 | 3-Pentanone | 0.062 | 0.181 | [Mg_{0.80}Al_{0.20}(OH)₂(CO₃)_{0.125}]•0.062H₂O•0.181(3-Pentanone) |
| | Diisopropylketone | 0.310 | 0.053 | [Mg_{0.80}Al_{0.20}(OH)₂(CO₃)_{0.125}]•0.310H₂O•0.053(Diisopropylketone) |
| | 4-Heptanone | 0.309 | 0.059 | [Mg_{0.80}Al_{0.20}(OH)₂(CO₃)_{0.125}]•0.309H₂O•0.059(4-Heptanone) |

In the ether solvent series, it was found that the LDHs can totally be dispersed in most ether solvents. FIG. 13 shows the BET surface area of the various ether AIM-LDHs, whereas FIG. 14 shows the bulk and tap densities of these LDHs. These data show that, with the exception of anisole, all ether solvents gave rise to comparable surface area and density properties. Without wishing to be bound by theory, the lower surface area and higher density values observed in respect of anisole may be attributed to the steric bulk of the phenyl group, preventing the solvent from readily hydrogen bonding to surface-bonded water on the LDH.

FIG. 15 shows BET isotherms of the ether AIM-LDHs, with some hysteresis observed in respect of the anisole-washed sample.

FIG. 16 shows that the various ether AIM-LDHs are micro/mesoporous materials.

In the ketone solvent series, it was found that the LDHs can totally be dispersed in the ketone solvents. FIG. 17 shows the BET surface area of the various ketone AIM-LDHs, whereas FIG. 18 shows the bulk and tap densities of these LDHs. These data show that all ketone solvents gave rise to broadly comparable surface area and density properties. Without wishing to be bound by theory, the slightly lower surface area and higher density values observed in respect of 4-heptanone and 5-nonanone may be attributed to the steric bulk of the longer alkyl chains, which may prevent the solvent from readily hydrogen bonding to surface-bonded water on the LDH.

FIG. 19 shows BET isotherms of the ketone AIM-LDHs.

FIG. 20 shows that the various ketone AIM-LDHs are micro/mesoporous materials.

### Example 8—Effect of Dispersion Time

The effect of AIM solvent dispersion time on the properties of the AIM-LDH (BET surface area, density, pore volume and pore size distribution) was investigated.

Using the general protocol outlined in Example 5, a series of AIM-LDHs were prepared (AIM solvents—diisopropyl ether, di-n-butyl ether, anisole and cyclopentyl methyl ether), in which the dispersion time of the LDH in the AIM solvent was varied between 4 and 24 hours.

Table 12 below shows the water and solvent content of the AIM-LDHs used in this study, as determined by elemental analysis.

TABLE 12
Elemental composition of AIM-LDHs

| AIM | Dispersion | | | |
|---|---|---|---|---|
| solvents | time | b | c | Formula of LDHs |
| Diisopropyl | 4 h | 0.525 | 0.012 | [Mg_{0.80}Al_{0.20}(OH)₂(CO₃)_{0.125}]•0.525H₂O•0.012(Diisopropyl ether) |
| ether | 8 h | 0.260 | 0.013 | [Mg_{0.80}Al_{0.20}(OH)₂(CO₃)_{0.125}]•0.260H₂O•0.013(Diisopropyl ether) |
| Di-n-butyl | 4 h | 0.630 | 0.013 | [Mg_{0.80}Al_{0.20}(OH)₂(CO₃)_{0.125}]•0.630H₂O•0.013(Di-n-butyl ether) |
| ether | 8 h | 0.387 | 0.009 | [Mg_{0.80}Al_{0.20}(OH)₂(CO₃)_{0.125}]•0.387H₂O•0.009(Di-n-butyl ether) |
| Cyclopentyl | 4 h | 0.490 | 0.011 | [Mg_{0.80}Al_{0.20}(OH)₂(CO₃)_{0.125}]•0.490H₂O•0.011(Cyclopentyl methyl ether) |
| methyl | 24 h | 0.328 | 0.056 | [Mg_{0.80}Al_{0.20}(OH)₂(CO₃)_{0.125}]•0.328H₂O•0.056(Cyclopentyl methyl ether) |
| ether | | | | |
| Anisole | 4 h | 0.506 | 0.007 | [Mg_{0.80}Al_{0.20}(OH)₂(CO₃)_{0.125}]•0.506H₂O•0.007(Anisole) |
| | 24 h | 0.022 | 0.009 | [Mg_{0.80}Al_{0.20}(OH)₂(CO₃)_{0.125}]•0.022H₂O•0.009(Anisole) |

FIG. 21 shows the BET surface area of the various AIM-LDHs, whereas FIG. 22 shows the bulk and tap densities of these LDHs. With the exception of anisole, the data demonstrate that effective AIM solvent treatment can be achieved in 4 hours. Without wishing to be bound by theory, the lower surface area and higher density values observed at 4 hours in respect of anisole may be attributed to the steric bulk of the phenyl group, preventing the solvent from readily hydrogen bonding to surface-bonded water on the LDH. Nonetheless, it is seen that effective AIM solvent treatment can be achieved in 24 hours using anisole.

FIG. 23 shows BET isotherms of the AIM-LDHs.

FIG. 24 shows that the various ketone AIM-LDHs are micro/mesoporous materials.

### Example 9—Effect of Recycling Solvent

The benefits of using AIM solvents over AMO solvents were investigated by comparing the effect of using recycled solvents in the rinsing step of the LDH manufacturing process. In the protocol described in Example 5, the rinsing step uses the largest quantity of solvent. Hence, the ability to use recycled solvent in this step would be a key advantage.

An AIM-LDH was prepared (AIM-LDH1) according to the protocol described in Example 5, except that after filtering the 25 mL dispersion and then rinsing the wet cake LDH with 500 mL of hexanol, the filtrate (containing hexanol and water) was collected and water was removed therefrom with the aid of a separating funnel. The protocol described in Example 5 was then resumed to afford the finished AIM-LDH1. The recycled hexanol from the rinsing step of AIM-LDH1 was then used in the same rinsing step of a subsequent batch of AIM-LDH (AIM-LDH2), after which the filtrate was again collected and water was separated from hexanol. The protocol described in Example 5 was then resumed to afford the finished AIM-LDH2. The hexanol was recycled a total of 4 times, with the BET surface area and density for each resulting LDH (AIM-LDH1-5) being recorded.

A series of AMO-LDHs were prepared according to an analogous procedure to the one described above, except that the AMO-solvent (ethanol) was not separated from water as part of each solvent recycling step.

Table 13 below shows the water and solvent content of the AIM-LDHs and AMO-LDHs used in this study, as determined by elemental analysis.

TABLE 13
Elemental composition of AIM-LDHs and AMO-LDHs

| | Solvent | | | |
|---|---|---|---|---|
| Washing | recycle | | | |
| solvent | time(s) | b | c | Formula of LDHs |
| Ethanol | 0 | 0.245 | 0.215 | [Mg_{0.80}Al_{0.20}(OH)₂(CO₃)_{0.125}]•0.245H₂O•0.215(Ethanol) |
| (AMO) | 1 | 0.018 | 0.268 | [Mg_{0.80}Al_{0.20}(OH)₂(CO₃)_{0.125}]•0.018H₂O•0.268(Ethanol) |
| | 2 | 0.019 | 0.247 | [Mg_{0.80}Al_{0.20}(OH)₂(CO₃)_{0.125}]•0.019H₂O•0.247(Ethanol) |
| | 3 | 0.045 | 0.215 | [Mg_{0.80}Al_{0.20}(OH)₂(CO₃)_{0.125}]•0.045H₂O•0.215(Ethanol) |
| | 4 | 0.048 | 0.219 | [Mg_{0.80}Al_{0.20}(OH)₂(CO₃)_{0.125}]•0.048H₂O•0.219(Ethanol) |
| Hexanol | 0 | 0.232 | 0.113 | [Mg_{0.80}Al_{0.20}(OH)₂(CO₃)_{0.125}]•0.232H₂O•0.113(1-Hexanol) |
| (AIM) | 1 | 0.257 | 0.091 | [Mg_{0.80}Al_{0.20}(OH)₂(CO₃)_{0.125}]•0.257H₂O•0.091(1-Hexanol) |
| | 2 | 0.260 | 0.146 | [Mg_{0.80}Al_{0.20}(OH)₂(CO₃)_{0.125}]•0.260H₂O•0.146(1-Hexanol) |
| | 3 | 0.240 | 0.188 | [Mg_{0.80}Al_{0.20}(OH)₂(CO₃)_{0.125}]•0.240H₂O•0.188(1-Hexanol) |
| | 4 | 0.172 | 0.225 | [Mg_{0.80}Al_{0.20}(OH)₂(CO₃)_{0.125}]•0.172H₂O•0.225(1-Hexanol) |

FIG. 25 shows that as the number of AMO solvent recycling steps increases, the surface area of the AMO-LDH decreases. In contrast to this, FIG. 25 shows that AIM solvent recycling has no deleterious effect on the surface area of the AIM-LDH.

It will be appreciated that recycled AMO-solvent contains a quantity of water. Due to its miscibility with water, the AMO-solvent cannot—unlike AIM-solvents—be straightforwardly separated from water. Without wishing to be bound by theory, it is believed that the presence of water in the recycled AMO solvent causes re-adsorption of some water molecules to the surface of the LDH during the rinsing of subsequent LDH batches, which manifests itself as a lower LDH surface area. In contrast to this, the immiscibility of the AIM solvent with water allows water to be straightforwardly separated from the AIM-solvent, meaning that notably purer solvent can be used in subsequent rinsing steps, thereby reducing the risk of water being re-adsorbed onto the surface of the LDH, thus giving rise to substantially identical surface area values across the 5 AIM-LDH samples. FIG. 26 shows a similar trend for tap density of the AMO- and AIM-LDHs.

Given the high costs associated with rinsing LDHs with large quantities of solvent, the ability to recycle such solvents without deleterious effect to the LDH properties is significant.

### Example 10—Effect of Solvent Rinsing Volume

The effect of solvent rinsing volume on the composition of the AIM-LDH was studied. Following the general protocol outlined at Example 5, a variety of AIM-LDHs were prepared (AIM solvents—1-butanol, 1-hexanol and diethyl ether) in which the wet cake was initially rinsed with either 500 mL of AIM solvent (as in Example 5) or 100 mL of AIM solvent.

Table 14 below shows the water and solvent content of the AIM-LDHs used in this study, as determined by elemental analysis.

TABLE 14
Elemental composition of AIM-LDHs

| | Rinsing | | | |
|---|---|---|---|---|
| Solvent | volume (mL) | b | c | Formula of LDHs |
| 1-Butanol | 100 mL | 0.220 | 0.118 | [Mg_{0.80}Al_{0.20}(OH)₂(CO₃)_{0.125}]•0.220H₂O•0.118(1-Butanol) |
| | 500 mL | 0.041 | 0.099 | [Mg_{0.80}Al_{0.20}(OH)₂(CO₃)_{0.125}]•0.041H₂O•0.099(1-Butanol) |
| 1-Hexanol | 100 mL | 0.176 | 0.075 | [Mg_{0.80}Al_{0.20}(OH)₂(CO₃)_{0.125}]•0.176H₂O•0.075(1-Hexanol) |
| | 500 mL | 0.110 | 0.087 | [Mg_{0.80}Al_{0.20}(OH)₂(CO₃)_{0.125}]•0.110H₂O•0.087(1-Hexanol) |
| Diethyl | 100 mL | 0.537 | 0.089 | [Mg_{0.80}Al_{0.20}(OH)₂(CO₃)_{0.125}]•0.537H₂O•0.089(Diethylether) |
| ether | 500 mL | 0.370 | 0.021 | [Mg_{0.80}Al_{0.20}(OH)₂(CO₃)_{0.125}]•0.370H₂O•0.021(Diethylether) |

### Example 11—Effect of Solvent Treatment on Platelet-Like LDHs

The effect of solvent treatment (AIM or AMO) on platelet-like LDHs was explored. Unlike the rosette-type LDHs (also termed flower LDHs) discussed in Examples 1-10, platelet-like LDH have a plate-like morphology, and are composed of fewer layers. The platelet-like LDHs were prepared as follows:

An aqueous solution (100 mL) of 0.40 M Mg(NO₃)₂.6H₂O, 0.10 M of Al(NO₃)₃.9H₂O, and 0.80 M urea was prepared. The mixed solution were transferred to a Teflon-lined autoclave and heated in an oven at the 100° C. for 24 hours. After the reactions were cooled to room temperature, the precipitate products were washed several times with deionised water by filtration until the pH was close to 7. Then the wet cake was re-dispersed in 100 mL of deionised water. The 25 mL of dispersion was filtered to remove water. The wet cake was rinsed with 500 mL of an AIM- or AMO-solvent then re-dispersed and stirred in 300 mL of this solvent at room temperature for 4 hours. The solvent was removed by filtration and the obtained LDHs was further rinsed by 200 mL of this solvent. The product was dried in the vacuum oven overnight. The solvents used were acetone, ethanol, 1-hexanol and diethyl ether.

A conventional platelet-like LDH (c-LDH) was also prepared according to the above described urea hydrothermal method, omitting the AIM- or AMO-solvent treatment step.

The XRD patterns shown in FIG. 27 demonstrate that the platelet-like AIM and AMO-LDHs exhibit the same structure as the conventional, water-washed platelet-like LDH.

FIG. 28 shows that higher surface areas are generally offered by the platelet-like AIM-LDHs. It will be understood that platelet-like LDHs have a lower surface area than rosette-type LDHs due to their larger overall size. Density data for the various platelet-like LDHs is presented in FIG. 29.

FIG. 30 shows the BET isotherms for the various platelet-like LDHs.

FIG. 31 demonstrates that the various platelet-like LDHs are microporous materials.

FIG. 32 shows SEM images of the various platelet-like LDHs.

### Comparative Example 1—Use of Weakly Hydrogen-Bonding Solvents

Comparative LDHs were prepared according to the general protocol outlined in Example 5 using weakly hydrogen bonding solvents (toluene, hexane, chloroform, cyclohexane and dichloromethane). For each solvent, a series of LDHs were prepared in which the dispersion time of the LDH in the solvent varied from 4 to 120 hours.

Table 15 below shows the water and solvent content of the comparative LDHs used in this study, as determined by elemental analysis.

TABLE 15
Elemental composition of comparative LDHs

| Weak | | | | |
|---|---|---|---|---|
| H-bond | Dispersion | | | |
| solvents | time | b | c | Formula of LDHs |
| Toluene | 4 h | 0.402 | 0.001 | [Mg_{0.80}Al_{0.20}(OH)₂(CO₃)_{0.125}]•0.402H₂O•0.001(Toluene) |
| | 24 h | 0.532 | 0.004 | [Mg_{0.80}Al_{0.20}(OH)₂(CO₃)_{0.125}]•0.532H₂O•0.004(Toluene) |
| | 48 h | 0.630 | 0.001 | [Mg_{0.80}Al_{0.20}(OH)₂(CO₃)_{0.125}]•0.630H₂O•0.001(Toluene) |
| | 72 h | 0.486 | 0.005 | [Mg_{0.80}Al_{0.20}(OH)₂(CO₃)_{0.125}]•0.486H₂O•0.005(Toluene) |
| Hexane | 4 h | 0.548 | 0.002 | [Mg_{0.80}Al_{0.20}(OH)₂(CO₃)_{0.125}]•0.548H₂O•0.002(Hexane) |
| | 24 h | 0.596 | 0.006 | [Mg_{0.80}Al_{0.20}(OH)₂(CO₃)_{0.125}]•0.596H₂O•0.006(Hexane) |
| | 48 h | 0.518 | 0.003 | [Mg_{0.80}Al_{0.20}(OH)₂(CO₃)_{0.125}]•0.518H₂O•0.0003(Hexane) |
| | 72 h | 0.550 | 0.004 | [Mg_{0.80}Al_{0.20}(OH)₂(CO₃)_{0.125}]•0.550H₂O•0.004(Hexane) |
| | 96 h | 0.356 | 0.017 | [Mg_{0.80}Al_{0.20}(OH)₂(CO₃)_{0.125}]•0.356H₂O•0.017(Hexane) |
| | 120 h | 0.211 | 0.020 | [Mg_{0.80}Al_{0.20}(OH)₂(CO₃)_{0.125}]•0.211H₂O•0.020(Hexane) |
| Chloroform | 4 h | 0.593 | 0.042 | [Mg_{0.80}Al_{0.20}(OH)₂(CO₃)_{0.125}]•0.593H₂O•0.042(Chloroform) |
| | 24 h | 0.683 | 0.020 | [Mg_{0.80}Al_{0.20}(OH)₂(CO₃)_{0.125}]•0.683H₂O•0.020(Chloroform) |
| | 48 h | 0.649 | 0.022 | [Mg_{0.80}Al_{0.20}(OH)₂(CO₃)_{0.125}]•0.649H₂O•0.022(Chloroform) |
| | 72 h | 0.430 | 0.045 | [Mg_{0.80}Al_{0.20}(OH)₂(CO₃)_{0.125}]•0.430H₂O•0.045(Chloroform) |
| Cyclohexane | 4 h | 0.467 | 0.004 | [Mg_{0.80}Al_{0.20}(OH)₂(CO₃)_{0.125}]•0.467H₂O•0.004(Cyclohexane) |
| | 24 h | 0.473 | 0.004 | [Mg_{0.80}Al_{0.20}(OH)₂(CO₃)_{0.125}]•0.473H₂O•0.004(Cyclohexane) |
| | 48 h | 0.455 | 0.006 | [Mg_{0.80}Al_{0.20}(OH)₂(CO₃)_{0.125}]•0.455H₂O•0.006(Cyclohexane) |
| | 72 h | 0.632 | 0.007 | [Mg_{0.80}Al_{0.20}(OH)₂(CO₃)_{0.125}]•0.632H₂O•0.007(Cyclohexane) |
| | 96 h | 0.483 | 0.006 | [Mg_{0.80}Al_{0.20}(OH)₂(CO₃)_{0.125}]•0.483H₂O•0.006(Cyclohexane) |
| | 120 h | 0.498 | 0.004 | [Mg_{0.80}Al_{0.20}(OH)₂(CO₃)_{0.125}]•0.498H₂O•0.004(Cyclohexane) |
| Dichloro | 4 h | 0.616 | 0.014 | [Mg_{0.80}Al_{0.20}(OH)₂(CO₃)_{0.125}]•0.616H₂O•0.014(Dichloromethane) |
| methane | 24 h | 0.896 | 0.230 | [Mg_{0.80}Al_{0.20}(OH)₂(CO₃)_{0.125}]•0.896H₂O•0.230(Dichloromethane) |
| | 48 h | 0.732 | 0.015 | [Mg_{0.80}Al_{0.20}(OH)₂(CO₃)_{0.125}]•0.732H₂O•0.015(Dichloromethane) |
| | 72 h | 0.771 | 0.196 | [Mg_{0.80}Al_{0.20}(OH)₂(CO₃)_{0.125}]•0.771H₂O•0.196(Dichloromethane) |

FIG. 33 shows the effect of increasing the dispersing time on the BET surface area of the resulting comparative LDHs. The data show that, when compared with the LDHs of the invention (see FIG. 21), the comparative LDHs exhibit notably lower surface area properties when the solvent dispersing step is performed for 4 hours. In fact, FIG. 33 shows that for weak hydrogen-bonding solvents, the solvent dispersing time must be increased to 72+ hours to obtain LDHs having surface areas approaching those of the LDHs of the invention. FIG. 34 shows a similar trend in respect of the bulk and tap densities of the comparative LDHs.

While specific embodiments of the invention have been described herein for the purpose of reference and illustration, various modifications will be apparent to a person skilled in the art without departing from the scope of the invention as defined by the appended claims.

1. A process for preparing a layered-double hydroxide of formula (I) shown below:
[M^{z+}₁₋ₓM′^{y+}ₓ(OH)₂]^{a}^{₊}(Xⁿ⁻)_{a/n}·bH₂O·c(AIM-solvent) (I)
wherein
M is a charged metal cation;
M′ is a charged metal cation different from M;
z is 1 or 2;
y is 3 or 4;
0<x<0.9;
0<b≤10;
0<c≤10;
X is an anion;
n is the charge on anion X;
a is equal to z(1−x)+xy−2; and
“AIM-solvent” denotes a solvent selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, 2-pentanone, 3-methyl-2-butanone, 3-pentanone, 2,4-dimethyl-3-pentanone, 4-heptanone, 5-nonanone, hexane, cyclohexane, toluene, dichloromethane, chloroform, and a mixture of two or more thereof;
said process comprising the steps of;
a) providing a water-washed, wet precipitate of formula (II) shown below, said precipitate having been formed by contacting aqueous solutions containing cations of the metals M and M′, and the anion Xⁿ⁻, and then ageing the reaction mixture:
[M^{z+}₁₋ₓM′^{y+}ₓ(OH)₂]^{a}^{₊}(Xⁿ⁻)_{a/n}·bH₂O (II)
wherein M, M′, z, y, x, a, b and X are as defined for formula (I);
b) dispersing the water-washed, wet precipitate of step a) in an AIM-solvent as defined for formula (I) to produce a slurry; and
c) maintaining the slurry resulting from step b).

2. The process of claim 1, further comprising a step d) of isolating the layered double hydroxide resulting from step c).

3. The process of claim 1, wherein the AIM-solvent is selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, and a mixture of two or more thereof.

4. (canceled)

5. (canceled)

6. The process of claim 1, wherein when z is 2, M is Mg, Zn, Fe, Ca, Sn, Ni, Cu, Co, Mn or Cd or a mixture of two or more of these, or when z is 1, M is Li.

7. The process of claim 1, wherein when y is 3, M′ is Al, Ga, Y, In, Fe, Co, Ni, Mn, Cr, Ti, V, La or a mixture thereof, or when y is 4, M′ is Sn, Ti or Zr or a mixture thereof.

8. (canceled)

9. (canceled)

10. The process of claim 1, wherein X is an anion selected from at least one of halide, inorganic oxyanion, or an organic anion (e.g. an anionic surfactant, an anionic chromophore or an anionic UV absorber).

11. (canceled)

12. The process of claim 1, wherein in step a), the precipitate is formed by contacting aqueous solutions containing cations of the metals M and M′, and the anion Xⁿ⁻, in the presence of a base.

13. (canceled)

14. (canceled)

15. (canceled)

16. The process of claim 1, wherein after step a) and prior to step b), the water-washed, wet precipitate of formula (II) is washed with an AIM-solvent.

17. (canceled)

18. (canceled)

19. (canceled)

20. (canceled)

21. The process of claims 2, further comprising the step e) of contacting the isolated layered double hydroxide with an AIM-solvent, optionally wherein step e) comprises the steps of:
i. dispersing the isolated layered double hydroxide in an AIM-solvent to form a slurry;
ii. maintaining the slurry for a period of 0.5 to 72 hours;
iii. isolating the layered double hydroxide resulting from step ii; and
iv. optionally repeating steps i. to iii. a further 1-10 times (e.g., once or twice).

22. (canceled)

23. A layered double hydroxide of formula (I) obtainable, obtained or directly obtained by the process of any proceeding claim.

24. A layered double hydroxide of formula (I) shown below:
[M^{z+}₁₋ₓM′^{y+}ₓ(OH)₂]^{a}^{₊}(Xⁿ⁻)_{a/n}·bH₂O·c(AIM-solvent) (I)
wherein
M is a charged metal cation
M′ is a charged metal cation different from M
z is 1 or 2
y is 3 or 4
0<x<0.9
0<b≤10
0<c≤10
X is an anion
n is the charge on anion X
a is equal to z(1−x)+xy−2; and
“AIM-solvent” denotes a solvent selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, 2-pentanone, 3-methyl-2-butanone, 3-pentanone, 2,4-dimethyl-3-pentanone, 4-heptanone, 5-nonanone, hexane, cyclohexane, toluene, dichloromethane, chloroform, and a mixture of two or more thereof.

25. The layered double hydroxide of claim 24, wherein M′ is Al.

26. The layered double hydroxide of claim 24, wherein the layered double hydroxide of formula (I) is a Zn/Al, Mg/Al, Ca/Al, Ni/Al or Cu/Al layered double hydroxide.

27. The layered double hydroxide of claim 24, wherein X is carbonate, bicarbonate, hydrogenphosphate, dihydrogenphosphate, nitrite, borate, nitrate, sulphate or phosphate or a mixture of two or more thereof.

28. (canceled)

29. The layered double hydroxide of claim 24, wherein the AIM-solvent is selected from the group consisting of m-cresol, o-cresol, p-cresol, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, anisole, butyl carbitol acetate, cyclohexanone, methyl ethyl ketone (MEK), methyl isobutyl ketone (MIBK), methyl isoamyl ketone, methyl n-amyl ketone, isophorone, isobutyraldehyde, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, 2-butoxyethyl acetate, n-butyl propionate, n-pentyl propionate, triethylamine, 2-nitropropane, aniline, N,N-dimethylaniline, nitromethane, and a mixture of two or more thereof.

30. (canceled)

31. The layered double hydroxide of claim 24, wherein 0<b≤5.

32. The layered double hydroxide of claim 24, wherein 0<c≤1.

33. The layered double hydroxide of claim 24, wherein the layered double hydroxide has a BET surface area of at least 180 m²/g.

34. The layered double hydroxide of claim 23, wherein the layered double hydroxide has a BET pore volume of at least 0.5 cm³/g.

35. The layered double hydroxide of claim 23, wherein the layered double hydroxide has a loose bulk density of less than 0.5 g/mL.
